(19) United States
(12) Patent Application Publication
(10) Pub. No.: US 2025/0388745 A1
(43) Pub. Date: Dec. 25, 2025

(54) HALOGEN FREE AND PHOSPHORUS FREE LOW LOSS FLAME RETARDANT COMPOSITIONS CONTAINING POLYCYCLIC-OLEFINIC POLYMER WITH OLEFINIC FUNCTIONALITY, MELAMINE AND CLAY

(71) Applicant: PROMERUS, LLC, AKRON, OH (US)

(72) Inventor: PRAMOD KANDANARACHCHI, AKRON, OH (US)

(73) Assignee: PROMERUS, LLC, AKRON, OH (US)

(21) Appl. No.: 19/248,786

(22) Filed: Jun. 25, 2025

Related U.S. Application Data
(60) Provisional application No. 63/663,770, filed on Jun. 25, 2024.

(51) Int. Cl. C08L 45/00; C08J 5/18; C08J 5/24; C08K 3/22; C08K 3/34; C08K 3/38; C08K 5/3492; C08K 13/02

(52) U.S. Cl. CPC C08L 45/00; C08J 5/18; C08J 5/244; C08J 5/249; C08K 13/02; C08J 2345/00; C08J 2409/00; C08J 2423/16; C08K 2003/2265; C08K 3/346; C08K 2003/385; C08K 5/34922; C08K 2201/014; C08L 2201/02; C08L 2203/16; C08L 2312/00; C08L 2314/06

(57) ABSTRACT

Embodiments in accordance with the present invention encompass compositions containing the polymer formed from a variety of polycycloolefinic monomers at least one of which monomer contains an additional unpolymerized ethylenic bond, melamine, clay such as bentonite or montmorillonite, optionally fillers such as hexagonal boron nitride or silica, a crosslinker, a free radical initiator, a tackifier and one or more suitable additives. The compositions of this invention can be formed into a variety of three-dimensional insulating articles upon exposure to suitable high temperature, such as for example films. The objects formed from the compositions of this invention exhibit hitherto unattainable low dielectric constant and low-loss properties, fire-retardancy and very high thermal properties. The compositions of this invention are useful in various applications, including as insulating materials in millimeter wave radar antennas, among others. The films formed from the compositions of this invention exhibit a UL-94 rating of at least V-1, dielectric constant (Dk) less than 2.9 and dielectric dissipation factor (Df) of less than 0.003.

### CROSS REFERENCE TO RELATED APPLICATIONS

This application claims the benefit of U.S. Provisional Application No. 63/663,770, filed Jun. 25, 2024, which is incorporated herein by reference in its entirety.

### BACKGROUND OF THE INVENTION

### Field of the Invention

Embodiments in accordance with the present invention relate generally to compositions containing polymers containing olefinic functionality in combination with melamine, clay, a tackifier, a crosslinker, a free radical initiator, optionally in combination with an iron compound and fillers such as, hexagonal boron nitride or silica, and one or more additives. The compositions as described herein are free of both halogen and phosphorus, thus offering further advantages. More specifically, the polymers employed herein are formed from two or more polycycloolefinic monomers, such as for example, norbornene type monomers, at least one of which monomers contain a free olefinic functionality. The compositions of this invention can readily be formed into films, which are useful as low loss thermosets and prepregs for copper clad laminates which not only exhibit low dielectric constant and low-loss properties but also very high thermal properties and exhibit excellent fire-retarding properties. For example, films formed from the compositions of this invention generally exhibit high glass transition temperature, which range from about 200° C. to 250° C., and also exhibit low dielectric constant (less than 2.8 at a frequency of 10 GHz), low dielectric dissipation factor (less than 0.002 at a frequency of 10 GHz). Accordingly, the polymers and composition of this invention find applications as insulating materials in a variety of applications including electromechanical devices having applications in the fabrication of a number of automotive parts, among others.

### Description of the Art

It is well known in the art that insulating materials having low dielectric constant (Dk) and low-loss, also referred to as dielectric dissipation factor, (Df) are important in printed circuit boards catering to electrical appliances and automotive parts and other applications. Generally, in most of such devices the insulating materials that are suitable must have dielectric constant lower than 3 and low-loss lower than 0.002 at high frequencies such as for example greater than 10 GHz. Also, there is an increased interest in developing organic dielectric materials as they are easy to fabricate among other advantages.

However, the use of such materials in printed circuit boards as copper-clad laminates need high performance thermosets having high glass transition temperatures (T_{g}), low coefficient of thermal expansion (CTE), low Dk/Df, high peel strength on copper and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in the art have not attained all of these properties, especially low Dk/Df and high glass transition temperatures, higher than 200° C.

In addition, there are significant technical challenges in developing such insulating materials meeting all of the requirements. One such challenge is that such materials exhibit very high glass transition temperature (T_{g}), which is preferably greater than 200° C. or even higher than 250° C. due to the process conditions used in the manufacture of printed circuit boards as well as harsh conditions the devices may encounter, such as for example millimeter-wave Radar antennas used in the automobiles and other terminal equipment in 5G devices.

Although films made from the addition polymerization of norbornene derivatives containing long side chains, such as for example, 5-hexylnorbornene (HexNB) and 5-decylnorbornene (DecNB) are known to have low Dk and Df due to their hydrophobic nature these films exhibit high CTE (>200 ppm/K) and low T_{g}. See, for example, JP 2016037577A and JP 2012121956A.

It has also been reported in the literature that certain of the polymers, such as for example, fluorinated poly-ethylene, poly-ethylene and poly-styrene feature low Dk/Df but all of such polymers are unsuitable as organic insulating materials as they exhibit very low glass transition temperatures, which can be lower than 150° C. Further, it has also been reported in the literature that generally low CTE and high T_{g} polymers can be formed when certain substituted norbornenes containing polar groups such as ester or alcohol groups are incorporated. However, incorporation of such groups will increase both Dk and Df due to their polarizability under an electromagnetic field, particularly at high frequencies. Therefore, such polar group substituted norbornenes are unsuitable in forming insulating materials as contemplated herein. In addition, there is a heightened need to ensure that the materials employed in such applications are fire-retardant due to high heat generated in many of the applications.

U.S. Pat. No. 10,104,769 B2 discloses a circuit subassembly embodiment containing a thermoset composition comprising a low polarity resin, an oxaphosphorinoxide-containing aromatic compound, which has a UL-94 rating of at least V-1. However, the embodiments reported therein exhibit high Dk of about 3.8 and high Df of about 0.006.

Therefore, there is still a need to develop new insulating materials that exhibit not only low dielectric properties, very high thermal properties but also good fire-retardant properties.

In addition, there is also a need to develop materials, which can form thermoset films rather than thermoplastic films. That is, the thermosets are generally cross-linked structures, which are more stable to higher temperatures and do not exhibit any thermal mobility unlike thermoplastics. Furthermore, there is also a need to develop fire-retardant materials, which do not release any toxic materials. For example, certain phosphorus containing and/or halogenated substances, which are currently employed as fire-retardant materials may pose environmental concerns if exposed to high temperatures.

There are reports in the literature that certain compositions containing melamine may be suitable as fire-retardant materials. However, most of such materials contain melamine derivatives such as melamine cyanurate, various forms of melamine phosphate, among other components, all of which not only lead to higher Dk/Df properties but also pose environmental concerns as they may release undesirable toxic by-products upon exposure to such high temperatures. See, for example, P. Qin et al., Composites Part B, 225, 109269, pp 1-13 (2021); and U. Braun et al., Polym. Adv. Technol. 19, 680-692 (2008).

Accordingly, it is an object of this invention to provide a fire-retardant composition exhibiting a UL-94 rating of V-0 and excellent dielectric and thermal properties, which contains a polymer having one or more monomers of substituted norbornenes, one of which monomer contains a free olefinic functionality, melamine, clay, and optionally an iron compound and fillers such as hexagonal boron nitride or silica, which can be formed into an insulating material having hitherto unattainable properties.

Other objects and further scope of the applicability of the present invention will become apparent from the detailed description that follows.

### SUMMARY OF THE INVENTION

Surprisingly, it has now been found that employing a composition that contains a polymer having one or more polycyclic olefinic monomers of formula (I) and a monomer of formula (II), as described herein, melamine, clay, a filler such as hexagonal boron nitride or silica and optionally an iron compound selected from the group consisting of a compound of formula (III) as described herein and ferric oxide, and in combination with certain other components as described herein, it is now possible to form a variety of three-dimensional objects, including films, which provide hitherto unattainable dielectric, thermal as well as excellent fire-retardant properties.

In another embodiment there is also provided a film forming composition that contains a polymer having two or more polycyclic olefinic monomers of formulae (I) and (II), as described herein, melamine, clay, a filer such as hexagonal boron nitride or silica and optionally an iron compound of formula (III) or ferric oxide, in combination with certain other components as described herein can be formed into films suitable as insulating materials that exhibit excellent fire-retardant properties.

In another aspect of this invention there is also provided a film, a composite, a prepreg comprising the compositions of this invention.

### DETAILED DESCRIPTION OF THE INVENTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” means a saturated, straight-chain or branched-chain hydrocarbon substituent having the specified number of carbon atoms. Particular alkyl groups are methyl, ethyl, n-propyl, isopropyl, tert-butyl, and so on. Derived expressions such as “alkoxy,” “thioalkyl,” “alkoxyalkyl,” “hydroxyalkyl,” “alkylcarbonyl,” “alkoxycarbonylalkyl,” “alkoxycarbonyl,” “diphenylalkyl,” “phenylalkyl,” “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy,” “cycloalkylalkyl,” “cycloalkylaryl,” “cycloalkylcarbonyl” are to be construed accordingly.

As used herein the expression “acyl” shall have the same meaning as “alkanoyl,” which can also be represented structurally as “R—CO—,” where R is an “alkyl” as defined herein having the specified number of carbon atoms. Additionally, “alkylcarbonyl” shall mean same as “acyl” as defined herein. Specifically, “(C₁-C₄)acyl” shall mean formyl, acetyl or ethanoyl, propanoyl, n-butanoyl, etc. Derived expressions such as “acyloxy” and “acyloxyalkyl” are to be construed accordingly.

As used herein, the expression “aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “arylalkyl” means that the aryl as defined herein is further attached to alkyl as defined herein. Representative examples include benzyl, phenylethyl, 2-phenylpropyl, 1-naphthylmethyl, 2-naphthylmethyl and the like.

As used herein, the expression “alkenyl” means a non-cyclic, straight, or branched hydrocarbon chain having the specified number of carbon atoms and containing at least one carbon-carbon double bond, and includes ethenyl and straight-chained or branched propenyl, butenyl, pentenyl, hexenyl, and the like. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like.

As used herein, the expression “heterocycle” includes all of the known reduced heteroatom containing cyclic radicals. Representative 5-membered heterocycle radicals include tetrahydrofuranyl, tetrahydrothiophenyl, pyrrolidinyl, 2-thiazolinyl, tetrahydrothiazolyl, tetrahydrooxazolyl, and the like. Representative 6-membered heterocycle radicals include piperidinyl, piperazinyl, morpholinyl, thiomorpholinyl, and the like. Various other heterocycle radicals include, without limitation, aziridinyl, azepanyl, diazepanyl, diazabicyclo[2.2.1]hept-2-yl, and triazocanyl, and the like.

As used herein, the expression “heteroaryl” includes all of the known heteroatom containing aromatic radicals. Representative 5-membered heteroaryl radicals include furanyl, thienyl or thiophenyl, pyrrolyl, isopyrrolyl, pyrazolyl, imidazolyl, oxazolyl, thiazolyl, isothiazolyl, and the like. Representative 6-membered heteroaryl radicals include pyridinyl, pyridazinyl, pyrimidinyl, pyrazinyl, triazinyl, and the like radicals. Representative examples of bicyclic heteroaryl radicals include, benzofuranyl, benzothiophenyl, indolyl, quinolinyl, isoquinolinyl, cinnolyl, benzimidazolyl, indazolyl, pyridofuranyl, pyridothienyl, and the like radicals.

“Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of (C₁-C₆)alkyl, (C₁-C₆)alkenyl, (C₁-C₆)perfluoroalkyl, phenyl, hydroxy, —CO₂H, an ester, an amide, (C₁-C₆)alkoxy, (C₁-C₆)thioalkyl and (C₁-C₆)perfluoroalkoxy. However, any of the other suitable substituents known to one skilled in the art can also be used in these embodiments.

It should be noted that any atom with unsatisfied valences in the text, schemes, examples, and tables herein is assumed to have the appropriate number of hydrogen atom(s) to satisfy such valences.

It will be understood that the terms “dielectric” and “insulating” are used interchangeably herein. Thus, reference to an insulating material or layer is inclusive of a dielectric material or layer and vice versa. Further, as used herein, the term “organic electronic device” will be understood to be inclusive of the term “organic semiconductor device” and the several specific implementations of such devices used, for example, in automotive industry.

As used herein, the dielectric constant (Dk) of a material is the ratio of the charge stored in an insulating material placed between two metallic plates to the charge that can be stored when the insulating material is replaced by vacuum or air. It is also called as electric permittivity or simply permittivity. And, at times referred as relative permittivity, because it is measured relatively from the permittivity of free space.

As used herein, “low-loss” is the dissipation factor (Df), which is a measure of loss-rate of energy of a mode of oscillation (mechanical, electrical, or electromechanical) in a dissipative system. It is the reciprocal of quality factor, which represents the “quality” or durability of oscillation.

As used herein, “B-stage” means a material wherein the reaction between the base polymer and the curing agent/hardener is not complete. That is, such “1B-staged” material is in a partially cured stage, and generally free of any solvent used to make the composition containing the base polymer and the curing agent/hardener. Generally, when such “° B-staged” material is reheated at elevated temperature, the cross-linking is complete, and the material is fully cured.

As used herein, “prepreg” means a material that is pre-impregnated with a polymeric material which can be either a thermoplastic or a thermoset. Generally, a fibrous material such as glass cloth is pre-impregnated with a polymeric material to form prepregs, which is formed by a “B-stage” process and subsequently cured by reheating at elevated temperature.

It is understood that the terms “room temperature” or “ambient temperature” are used interchangeably and generally refers to the temperature of from about 15° C. to about 30° C.

By the term “derived” is meant that the polymeric repeating units are polymerized (formed) from, for example, polycyclic norbornene-type monomers in accordance with formulae (I) or (II) wherein the resulting polymers are formed by 2,3 enchainment of norbornene-type monomers as shown below:

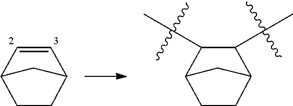

The above polymerization is also known widely as vinyl addition polymerization typically carried out in the presence of organometallic compounds such as organopalladium compounds or organonickel compounds as further described in detail below.

Thus, in accordance with the practice of this invention there is provided a composition comprising:
a) melamine;
b) a polymer selected from the group consisting of a first polymer having a weight average molecular weight (M_{w}) of at least 50,000, a second polymer having a weight average molecular weight (M_{w}) of at least 1,000 and a blend of the first polymer and the second polymer, where said polymer comprising:
   i) at least one first repeating unit represented by formula (IA), said first repeating unit is derived from a monomer of formula (I):

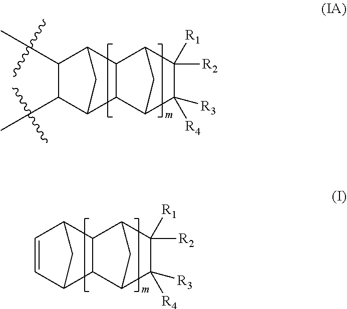

wherein:
[symbol] denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
ii) at least one second repeating unit represented by formula (IIA), said second repeating unit is derived from a monomer of formula (II):

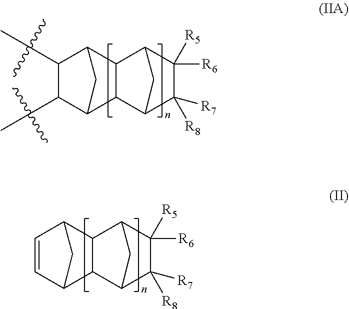

wherein:
[symbol] denotes a place of bonding with another repeat unit;
n is an integer 0, 1 or 2;
at least one of R₅, R₆, R₇ and R₈ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl; and
the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond; and
wherein the second repeat unit is present at an amount of at least ten mole percent based on total moles of first and second repeat units;
c) a crosslinking agent selected from the group consisting of:

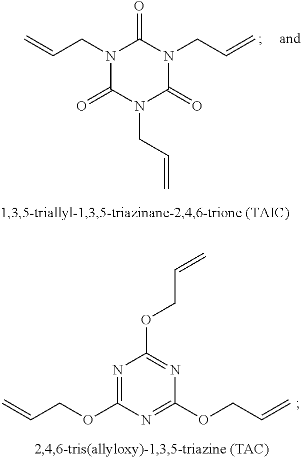

d) a clay selected from the group consisting of bentonite, kaolinite, sepiolite and montmorillonite;
e) a filler selected from the group consisting of hexagonal boron nitride and silica;
f) a tackifier; and
g) one or more additives selected from the group consisting of a free radical initiator, an antioxidant, a synergist and a mixture in any combination thereof; and
   wherein melamine is present at an amount of at least about 100 parts by weight based on 100 parts by weight of polymer and said composition when formed into a film has a UL-94 rating of at least V-1, a dissipation factor (Df) of less than 0.003 at 10 GHz.

It has now been found that use of melamine in excess of 100 parts per hundred parts of the polymer (generally abbreviated herein as “pphr”—parts per hundred parts resin, i.e., the polymer) it is now possible to form compositions of this invention which exhibit excellent flame retardant properties. In some embodiments the compositions of this invention when formed into films exhibit a UL-94 rating of at least V-1. In some other embodiments the compositions of this invention when formed into films exhibit a UL-94 rating of at least V-0. Generally, use of melamine in the amount of from about 100 pphr to 150 pphr results in not only improved flame retardant properties but also desirable dielectric properties as well as thermal properties. Accordingly, in some embodiments the amount of melamine present in the compositions of this invention is about 100 pphr, about 125 pphr or 150 pphr. However, it should be noted that higher than 150 pphr of melamine can also be used in some compositions of this invention depending upon the intended use. Accordingly, in some embodiments the amount of melamine present in the compositions of this invention is about 175 pphr, about 200 pphr or 250 pphr. In some embodiments the amount of melamine present in the compositions of this invention can be higher than 250 pphr. All such possible combinations are part of this invention.

The polymer as described herein can be prepared by any of the known vinyl addition polymerization in the art. See, for example, U.S. Pat. No. 11,845,880 B2, pertinent portions of which are incorporated herein by reference. It has now been found that the copolymerization of one or more monomers of formula (I) with one or more monomers of formula (II) it is now possible to form polymers in accordance with this invention where the additional olefinic functionality present in monomer of formula (II) remains unreactive during vinyl addition polymerization and such olefinic functionality remains available in the polymer for other uses. Thus, the polymers of this invention can be used in a variety of applications where further crosslinking with other materials can be carried out. Such methods include formation of prepregs suitable in the fabrication of printed circuit boards, such as copper clad laminates.

It has now been found that incorporation of second repeat unit of formula (IIA) in the amount higher than about ten mole percent based on total moles of first and second repeat units it is now possible to form polymers in accordance with this invention which are quite effective in forming crosslinkable compositions of this invention as described in detail below. Accordingly, in some embodiments of this invention the second repeat unit of formula (IIA) is present in the polymer in the range of from about ten mole percent to about forty mole percent; from about fifteen mole percent to about thirty-five mole percent; from about twenty mole percent to about thirty mole percent; and so on, based on total moles of first and second repeat units. But it should be noted that lower than ten mole percent or higher than forty mole percent of second repeat unit of formula (IIA) can be present in the polymer of this invention. All such possible combinations are part of this invention. Accordingly, in some embodiments the second repeat unit of formula (IIA) is present at an amount of four mole percent, five mole percent, six mole percent, seven mole percent, and so on.

It should further be noted that more than one monomer of formula (I) with at least one monomer of formula (II) can be used to form the polymer of this invention. Thus, in some embodiments the polymer of this invention is a copolymer formed by one monomer of formula (I) and one monomer of formula (II). In some other embodiments two distinctive monomers of formula (I) are employed with one monomer of formula (II) to form a terpolymer suitable for forming the compositions of this invention. Again, any desirable amounts of distinctive monomers of formula (I) can be used in combination with a monomer of formula (II) as described herein. In some embodiments such molar ratios of distinctive monomers of formula (I) can be 10:90, 20:80, 30:70, 40:60, 50:50, and so on.

In some embodiments, the polymer employed in the composition according to this invention is having a repeat units of formula (IA) wherein m is 0 or 1. In some other embodiments, the polymer employed in the composition according to this invention is having a repeat units of formula (IA) wherein m is zero. That is, the repeat units of formula (IA) are derived from a monomer of formula (I), which is a derivative of norbornene. Again, one or more distinct monomers of formula (I) can be used to form the polymer of this invention. In some other embodiments the monomer of formula (I) employed is having m equals 1. That is, the monomer employed in this embodiment contains a dimeric norbornene monomer unit, which is also known as tetracyclodecene (TD). However, it should be noted that a combination of monomers of formula (I) having m=0 and m=1 can also be used to form the polymer of this invention. That is, a mixture of norbornene derivatives of formula (I) as described herein can be employed with a suitable tetracyclodecene derivative of formula (I) as described herein to form the polymer of this invention. Again, any suitable amounts of these distinct monomers of formula (I) which will bring about the intended benefit can be employed to form the polymer of this invention. Accordingly, in some embodiments, the polymer according to this invention, encompasses the first repeat unit derived from two distinct monomers of formula (I).

Similarly, in some other embodiments, the polymer employed in the composition according to this invention is having a repeat units of formula (IIA) wherein n is 0 or 1. In some other embodiments, the polymer according to this invention is having a repeat units of formula (IIA) wherein n is zero. That is, the repeat units of formula (IIA) are derived from a monomer of formula (II), which is a derivative of norbornene. Again, one or more distinct monomers of formula (II) can be used to form the polymer of this invention. In some other embodiments the monomer of formula (II) employed is having n equals 1. That is, the monomer employed in this embodiment contains a dimeric norbornene monomer unit, which is also known as tetracyclodecene (TD). However, it should be noted that a combination of monomers of formula (II) having n=0 and n=1 can also be used to form the polymer of this invention. That is, a mixture of norbornene derivatives of formula (II) as described herein can be employed with a suitable tetracyclodecene derivative of formula (II) to form the polymer of this invention. Again, any suitable amounts of these distinct monomers which will bring about the intended benefit can be employed to form the polymers of this invention. Generally, one monomer of formula (II) is employed to form the polymer used in the compositions of this invention.

In some embodiments, R₁, R₂, R₃ and R₄ are the same or different and each independently selected from the group consisting of hydrogen, methyl, ethyl, n-propyl, n-butyl, n-hexyl, n-octyl, n-decyl, cyclopentyl, cyclohexyl and norbornyl.

In some other embodiments, one of R₁ and R₂ taken together with one of R₃ and R₄ and the carbon atoms to which they are attached to form a cyclopentyl, cyclohexyl, cycloheptyl, bicycloheptyl, bicyclooctyl, or adamantyl ring.

In yet some other embodiments, at least one of R₅, R₆, R₇ and R₈ is selected from the group consisting of ethylidene, vinyl, propenyl, butenyl, pentenyl, hexenyl, heptenyl, octenyl, cyclopentenyl and cyclohexenyl, and the remaining R₅, R₆, R₇ and R₈ are the same or different and each independently selected from the group consisting of hydrogen, methyl, ethyl, n-propyl, n-butyl, n-hexyl, n-octyl, n-decyl, cyclopentyl, cyclohexyl and norbornyl.

In some embodiments, one of R₅ and R₆ taken together with one of R₇ and R₈ and the carbon atoms to which they are attached to form a cyclopentenyl, cyclohexenyl, cycloheptenyl, bicycloheptenyl or bicyclooctenyl ring.

Again, any of the monomers of formula (I) within the scope of this invention can be employed to form the polymers of this invention. Non-limiting examples of such monomers of formula (I) may be selected from the group consisting of:

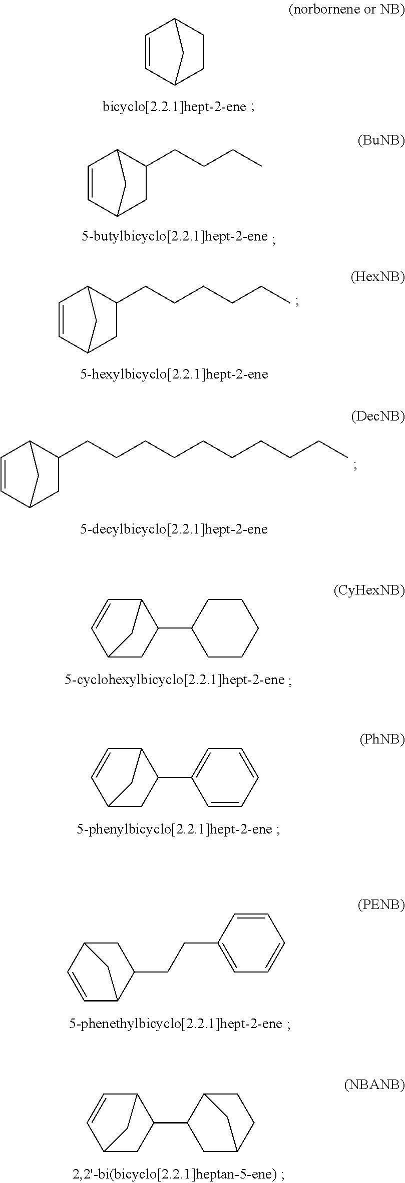

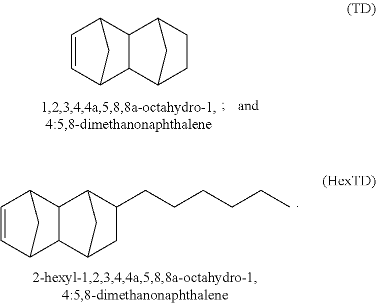

Similarly, any of the monomers of formula (II) within the scope of this invention can be employed to form the polymers of this invention. Non-limiting examples of such monomers of formula (II) may be selected from the group consisting of:

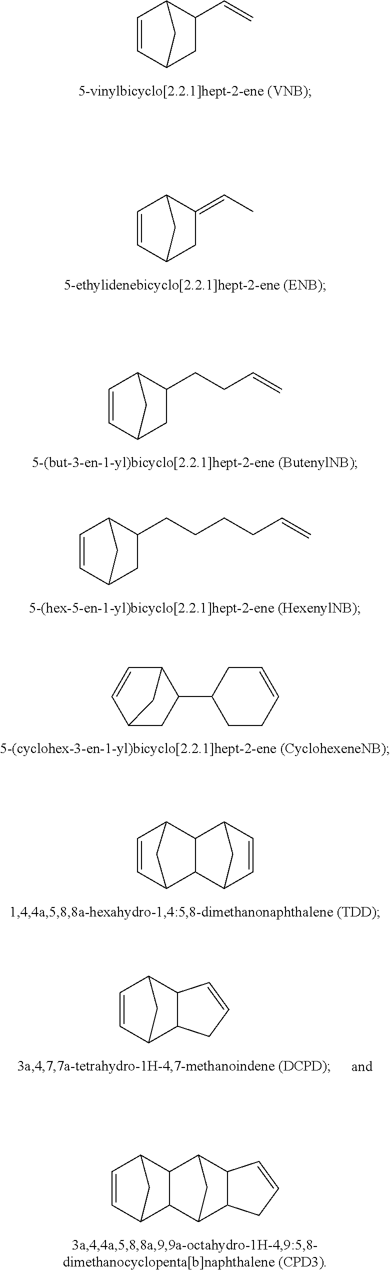

Exemplary non-limiting examples of polymer according to this invention may be enumerated as follows:
a copolymer of norbornene (NB) and 5-vinylbicyclo[2.2.1]hept-2-ene (VNB);
a copolymer of norbornene (NB) and 5-ethylidenebicyclo[2.2.1]hept-2-ene (ENB);
a copolymer of norbornene (NB) and 5-(but-3-en-1-yl)bicyclo[2.2.1]hept-2-ene (ButenylNB);
a copolymer of norbornene (NB) and 5-hex-5-en-1-yl)bicyclo[2.2.1]hept-2-ene (HexenylNB); and
a copolymer of norbornene (NB) and 5-cyclohex-3-en-1-yl)bicyclo[2.2.1]hept-2-ene (CyclohexeneNB);
a terpolymer of norbornene (NB), 5-butylbicyclo[2.2.1]hept-2-ene (BuNB) and 5-(but-3-en-1-yl)bicyclo[2.2.1]hept-2-ene (ButenylNB);
a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB);
a terpolymer of norbornene (NB), 5-phenethylbicyclo[2.2.1]hept-2-ene (PENB) and 5-(cyclohex-3-en-1-yl)bicyclo[2.2.1]hept-2-ene (CyclohexeneNB);
a terpolymer of norbornene (NB), 5-hexylbicyclo[2.2.1]hept-2-ene (HexNB) and 5-(but-3-en-1-yl)bicyclo[2.2.1]hept-2-ene (ButenylNB);
a terpolymer of norbornene (NB), 5-hexylbicyclo[2.2.1]hept-2-ene (HexNB) and 5-(hex-5-en-1-yl)bicyclo[2.2.1]hept-2-ene (HexenylNB);
a terpolymer of norbornene (NB), 5-hexylbicyclo[2.2.1]hept-2-ene (HexNB) and 5-vinylbicyclo[2.2.1]hept-2-ene (VNB);
a terpolymer of norbornene (NB), 5-phenethylbicyclo[2.2.1]hept-2-ene (PENB) and 5-vinylbicyclo[2.2.1]hept-2-ene (VNB); and
a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB).

It should be noted that the polymer employed in the composition of this invention can be a first polymer alone, which is generally of higher molecular weight. Again, such first polymer is formed using any of the methods known in the art. Most suitably, as noted hereinabove is formed by vinyl addition polymerization using a palladium catalyst. The higher or high molecular weight refers to weight average molecular weight (M_{w}), which can range from about 50,000 to about 150,000. Accordingly, in an embodiment, the polymer of this invention has a M_{w} of at least about 60,000. In another embodiment, the polymer of this invention has a M_{w} of at least about 70,000. In yet another embodiment, the polymer of this invention has a M_{w} of at least about 80,000. In some other embodiments, the polymer of this invention has a M_{w} of at least about 100,000, at least about 110,000, at least about 120,000, at least about 130,000, at least about 140,000, and so on. In another embodiment, the polymer of this invention has a M_{w} higher than 150,000, higher than 200,000, and can be higher than 500,000 in some other embodiments. The weight average molecular weight (M_{w}) of the polymer can be determined by any of the known techniques, such as for example, by gel permeation chromatography (GPC) equipped with suitable detector and calibration standards, such as differential refractive index detector calibrated with narrow-distribution polystyrene standards or polybutadiene (PBD) standards. The polymers of this invention typically exhibit polydispersity index (PDI) higher than 3, which is a ratio of weight average molecular weight (M_{w}) to number average molecular weight (Mₙ). In general, the PDI of the polymers of this invention ranges from 3 to 5. In some embodiments the PDI is higher than 3.5, higher than 4, higher than 5, or can be higher than 6. However, it should be noted that in some embodiments the PDI can be lower than 3, such as for example, 2.5, and so on.

It should further be noted that the polymer employed in the composition of this invention can be a second polymer alone, which is generally of lower molecular weight. Again, such second polymer is formed using any of the methods known in the art. Most suitably, as noted hereinabove is formed by vinyl addition polymerization using a palladium catalyst and a chain transfer agent (CTA). Various chain transfer agents can be used to control the molecular weight of the resulting second polymer as described herein, including for example, bicyclo[4.2.0]oct-7-ene (BCO), formic acid, various silanes, such as triethylsilane (TES), and the like, including mixtures in any combination thereof. Use of various CTAs in vinyl addition polymerization to control the resulting polymer properties is well known in the art. See, for example, U.S. Pat. No. 9,771,443 B2, pertinent portions of which are incorporated herein by reference. The lower or low molecular weight refers to weight average molecular weight (M_{w}), which can range from about 1,000 to about 10,000. Accordingly, in some embodiments, the second polymer of this invention has a M_{w} of at least about 2,000, 3,000, 4,000, 5,000, 6,000, 7,000, 8,000 or 9,000. In some embodiments the second polymer has a M_{w} higher than 10,000 but lower than 20,000.

Advantageously, it has now been found that a blend of first and second polymer provides various beneficial effects in forming the composition of this invention. For example, by employing judicious amounts of first polymer and second polymer in a blend it is now possible to control the film quality of the composition. The blend can also improve the process/flow properties of the composition, among other benefits that can be envisaged. Accordingly, in some embodiments, the polymer employed in the composition of this invention is a blend of the first polymer and the second polymer. Any amounts of the first and second polymer can be used to form the polymer blend depending on the intended end use of the composition. Accordingly, in some embodiments the blend contains at least 40 parts by weight of first polymer based on combined weights of first and second polymer, that is 100 parts by weight of the blend. In some other embodiments the blend contains 50, 60, 70 or 80 parts by weight of the first polymer. In some other embodiments, the blend contains at least 20 parts by weight of the second polymer based on 100 parts by weight of the blend.

The polymer thus formed is then used to make the compositions as described herein, which is used to produce composite materials exhibiting excellent properties, such as for example, low coefficient of thermal expansion (CTE), which can be as low as 100 ppm/° K, below 90 ppm/° K, 80 ppm/° K, 70 ppm/° K, 60 ppm/° K, 50 ppm/° K, 40 ppm/° K or lower than 40 ppm/° K. The composition of this invention also exhibits extremely low dielectric constant as well as low loss properties. For example, dielectric constant (Dk) of the polymer of this invention can be as low as 2.8 or lower and can be in the range of from about 2.2 to about 3.2 at a frequency of 10 GHz. The low loss (Df) of the polymer can be lower than 0.0015, and may range from about 0.001 to 0.002. In addition, the polymer of this invention exhibits extremely high glass transition temperature (T_{g}), which can be higher than 250° C., and generally ranges from about 250° C. to 350° C. Even more importantly, the composition of this invention readily binds with other crosslinkable materials as illustrated further below. The compositions thus formed exhibit excellent peel strength, generally ranging from 2 to 8 N/cm, thus finding many applications for example as copper clad laminates.

Any amount of the polymer as described herein can be used in the composition of this invention which brings about the intended benefit. Generally, as used herein the amount of polymer is fixed as 100 parts of the resin, and such polymer amount can range from about 20 weight percent to about 80 weight percent based on the total weight of the composition. However, it should be noted that in some embodiments the amount of polymer employed can be lower than 20 weight percent or can be higher than 80 weight percent, all such permissible combinations are well within the scope of this invention.

As noted, the composition of this invention contains a clay. As used herein “clay” refers to any of the metal silicates known in the art and commonly used as acidic catalysts, among other uses, and also referred to as clay acid catalysts. Any of such clay materials are suitable and can be included in the composition of this invention. Broadly such clay materials exist as aluminum phyllosilicates, sometimes with variable amounts of iron, magnesium, alkali metals, including lithium, sodium and potassium and/or alkaline earth metals, including beryllium, magnesium, calcium, strontium and barium, and other cations found on earth surface. Non-limiting examples of such clays that are suitable to be employed in the composition of this invention include, montmorillonite (SiO₂/AlO₂), bentonite ((Na, Ca)_{0.33}(Al, Mg)₂(Si₄O₁₀)(OH)₂H₂O), kaolinite (Al₂Si₂O₅(OH)₄) and sepiolite (Mg₄Si₆O₁₅(OH)₂·6H₂O). Various other examples of clay include serpentinite, talc, vermiculite, hydromica or hydromuscovite, smectite, dickite, halloysite, nacrite, nontronite, beidellite, saponite, chlorite, palygorskite, among others.

Any amount of clay can be used in the composition of this invention so as to bring about the intended benefit. It should also be noted that more than one type of clay can be used. For example, two different types of clay can be used in the composition of this invention, which can be a mixture of kaolinite and montmorillonite or any such suitable combination of clay materials as described herein. Generally, the amount of clay in the composition of this invention can range from about 2 to 30 parts per hundred parts of polymer (pphr), 3 to 25 pphr, 5 to 20 pphr, 8 to 18, and so on. When a combination of clays are used in the composition the amounts of each can be same or different. The total amount of clay may be around 3 to 30 pphr, 5 to 25 pphr, 15 to 20 pphr, 10 to 15 pphr, and so on. Again, it should be noted that such amounts can be higher or lower depending upon the intended use of the composition.

In a further aspect, the composition of this invention further comprises an iron compound selected from the group consisting of ferric oxide and a compound of formula (III):

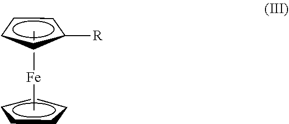

wherein:
R is selected from the group consisting of hydrogen, methyl, ethyl, linear or branched (C₃-C₁₆)alkyl, vinyl, linear or branched (C₃-C₁₆)alkenyl, (C₃-C₁₀)cycloalkyl, (C₆-C₁₂)bicycloalkyl, (C₆-C₁₂)aryl, (C₆-C₁₂)aryl(C₁-C₆)alkyl, (C₂-C₁₆)alkanoyl, di-(C₁-C₆)alkylamino(C₃-C₆)alkyl, di-(C₁-C₆)alkylamino, hydroxy, hydroxy(C₁-C₆)alkyl, methoxy, ethoxy, linear or branched (C₃-C₁₆)alkoxy and (C₆-C₁₂)aryloxy;

Advantageously it has now been observed that inclusion of an iron compound as described herein further enhances the fire-retardant properties of the composition of this invention. Surprisingly, even use of small quantity, for example just about two parts per hundred parts of polymer (pphr) of iron compound as described herein improves fire-retardant properties of the composition of this invention. That is, the iron compound acts as a synergist in combination with melamine in enhancing the fire-retardant properties of the composition of this invention. Even more advantageously several of the iron compounds of formula (III) are miscible with various components used in the composition of this invention providing additional benefits. Interestingly, it has also been observed that use of ferric oxide also provides similar benefits as that of a compound of formula (III). Further, ferric oxide provides high temperature stability to the composition of this invention, among many other benefits. As noted, only small amounts of any one of iron compounds as described herein is sufficient to provide improved fire-retardant properties. Accordingly, in some embodiments the iron compound present in the composition of this invention is at an amount of at least two parts by weight based on 100 parts by weight of the polymer (i.e., 2 pphr). In some other embodiments the iron compound is present at an amount of 3 pphr, 4 pphr, 5 pphr, 6 pphr, 7 pphr, 8 pphr, 9 pphr, 10 pphr or higher. In some other embodiments the iron compound is present at an amount less than 2 pphr, for example, 1.5 pphr, 1 pphr, 0.5 pphr or lower. In some other embodiments the iron compound is present at an amount higher than 10 pphr, for example, 11 pphr to 15 pphr or higher. Any of such desirable amount of iron compound is well within the scope of this invention.

It has been further observed that when the iron compound employed in the composition of this invention is ferric oxide, it should be of high purity such that desirable low loss properties of the composition can be maintained. Accordingly, in some embodiments the purity of the ferric oxide employed is greater than 97%, greater than 98%, greater than 99%, greater than 99.5%, greater than 99.9% or even greater than 99.9995%.

Exemplary non-limiting examples of iron compound of formula (III) according to this invention may be enumerated as follows:

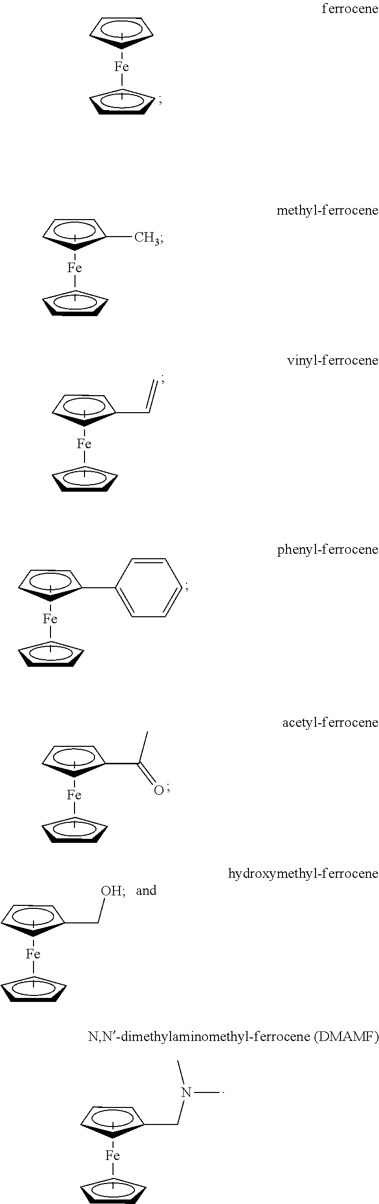

As noted, the composition according to this invention contains at least one crosslinking agent, which can be either TAIC or TAC. In some embodiments the composition according to this invention can contain a mixture of both TAIC and TAC.

Any amount of the crosslinking agents, TAIC or TAC, either taken alone, or in combination, can be used in the composition of this invention so as to bring about the intended benefit. Accordingly, in some embodiments the composition contains only TAIC as the crosslinking agent. In some other embodiments the composition contains only TAC as the crosslinking agent. In yet some other embodiments the composition contains a mixture of both TAIC and TAC as the crosslinking agents. Generally, the amount of TAIC or TAC used alone in the composition of this invention can range from about 5 to 20 parts per hundred parts of polymer (pphr), 8 to 18 pphr, 10 to 16 pphr, and so on. When a combination of TAIC and TAC are used in the composition the amounts of each can be same or different. The total amount of TAIC and TAC may be around 10 to 30 pphr, 15 to 25 pphr, and so on. Again, it should be noted that such amounts can be higher or lower depending upon the intended use of the composition.

Advantageously, it has now been observed that various other crosslinking agents which will bring about similar effect as that of TAIC or TAC can also be used in the composition of this invention. A few of such crosslinking agents include without any limitation 1,2,4-trivinyl cyclohexane, trimethylolpropane triacrylate, trimethylolpropane trimethacrylate, and the like. Other such suitable materials include oligomeric or low molecular weight polyphenylene oxide or poly-aryl ether cross linker end capped with vinyl or methacrylate groups, for example, SA90 or SA9000 are commercially available from SABIC.

The composition of this invention additionally contains one or more fillers. Surprisingly, it has now been observed that use of one or more fillers in the composition of this invention further improves various desirable properties as fire-retardant materials. For example, use of fillers improves the coefficient of thermal expansion (CTE) of the composition, among other improvements in performance of the composition of this invention as low loss materials. Even more importantly, use of such fillers do not affect the low loss properties. Non-limiting examples of fillers that can be employed in the composition of this invention include hexagonal boron nitride and silica.

More specifically, it has now been found that use of hexagonal boron nitride (h-BN) in the composition according to this invention provides synergistic benefit. That is, it has now been found that by employing h-BN having suitable particle size not only improves high thermal properties needed for various applications but also improves much needed fire-retarding properties, among others, such as for example, peel strength when applied to metal substrates such as copper, thus providing exceptional advantage in a variety of applications where copper clad laminates are employed, such as for example, printed circuit boards, mm-Wave Radar Antenna, and the like.

Advantageously it has further been found that the low dielectric properties of the films formed from the composition of this invention can be improved by incorporating h-BN. That is, the compositions of this invention exhibit generally lower dielectric constant (Dk) and lower dissipation factor (Df) when appropriate amount of h-BN is used in the composition of this invention. Generally, the boron nitride employed in the composition of this invention is in the form of hexagonal crystal structure. It is well known in the art that h-BN is available in the form of a powder, which includes flakes, platelets, and other shapes. In some embodiments the h-BN employed in the composition of this invention is in the form of platelets. The exact shape of the platelets is not critical. In this regard, h-BN platelets can have irregular shapes. As used herein, the term “platelets” is generally descriptive of any thin, flattened particles, inclusive of flakes. However, other forms of h-BN can also be used, which include fibers, rods, whiskers, sheets, nanosheets, agglomerates, or boron nitride nanotubes, and can vary as to crystalline type, shape, or size, and including a distribution of the foregoing. The h-BN particles can have an average aspect ratio (the ratio of width or diameter to length of a particle) of 1:2 to 1:100,000, or 1:5 to 1:1,000, or 1:10 to 1:300. Exemplary shapes of particles having particularly high aspect ratios include platelets, rod-like particles, fibers, whiskers, and the like. The platelets can have an average aspect ratio (the ratio of width to length of a particle) of 4:5 to 1:300, or 1:2 to 1:300, or 1:2 to 1:200, or 3:5 to 1:100, or 1:25 to 1:100.

Although the composition of this invention contains hexagonal boron nitride. Other forms of boron nitride can also be used in the composition of this invention, which include cubic, wurtzite, rhombohedral, or other synthetic structure. h-BN has a layered structure, analogous to graphite, in which the layers are stacked in registration such that the hexagonal rings in layers coincide. The positions of N and B atoms alternate from layer to layer. The h-BN particles can be obtained from a variety of commercial sources. Boron nitride particles, crystalline or partially crystalline, can be made by processes known in the art. These include, for example, boron nitride powder produced from the pressing process disclosed in U.S. Pat. Nos. 5,898,009 and 6,048,511, the boron nitride agglomerated powder disclosed in U.S. Patent Publication No. 2005/0041373. A variety of boron nitride powders are commercially available, for example, from St. Gobain.

Generally, the particle size distribution of h-BN can vary significantly and lower the particle size better it is to form homogeneous composition of this invention. Accordingly, in some embodiments the average particle size of h-BN employed is less than 0.05 micrometer (i.e., less than 50 nanometers). In some other embodiments the average particle size of h-BN employed is in the range of from about 0.05 micrometer to about 70 micrometer. In yet some other embodiments the average particle size of h-BN employed is in the range of from about 0.1 micrometer to about 30 micrometer; 0.1 micrometer to about 20 micrometer; 0.1 micrometer to about 20 micrometer, and so on.

In some embodiments the filler used in the composition of this invention is silica. Various forms of silica available in the art can be used in the composition of this invention. Generally, suitable form of silica include silica nanoparticles available commercially from Adamatech Co. Ltd., among other sources.

Any amount of fillers, such as h-BN or silica can be used which will bring about the intended benefit and depending upon the end application of the composition. For example, by incorporation of suitable amounts of h-BN into the composition of this invention it is now possible to obtain not only excellent dielectric and low loss properties as well as very high thermal properties, including excellent fire-retarding property. In addition, it should be noted that h-BN not only acts as an insulating material in various electronic applications but also provides an excellent thermal conductivity and the heat is dissipated faster than the conventional insulating materials, thus composition of this invention is especially suitable for fabricating micro-electronic devices where heat is generated and needs to be dissipated, such as for example mm-Wave Radar Antenna, among others. It is well known in the art that boron nitride has one of the highest thermal conductivity coefficients (751 W/mK at room temperature) among semiconductors and electrical insulators, and its thermal conductivity increases with reduced thickness due to less intra-layer coupling. For comparison, the thermal conductivity of silica particles is around 1.3 W/mK at room temperature. Therefore, depending upon the type of h-BN used and depending upon the amount of h-BN used in the composition of this invention it is now possible to tailor compositions having very high thermal conductivity. The thermal conductivity can be measured by any of the methods known in the art, such as for example, procedures as set forth in ASTM D5470-17, using a TIM Tester 1300.

In some embodiments the amount of filler (i.e., h-BN) present in the composition of this invention may be in an amount in the range of from about 30 parts by weight to about 80 parts by weight per 100 parts by weight of the polymer, i.e., 30 pphr to 80 pphr. In some other embodiments the amount of filler employed can be lower than 30 pphr, for example 25 pphr or lower. In some embodiments the amount of filler can be at least 20 pphr. In some other embodiments the amount of filler present in the composition of this invention is at an amount in the range of from about 25 pphr to about 75 pphr. In yet other embodiments such amounts can vary from about 35 pphr to about 60 pphr, from about 40 pphr to about 60 pphr, and so on. However, it should be noted that lower than 20 pphr or higher than 80 pphr, can also be employed in the composition of this invention where there is such need in fabricating suitable devices.

It should be noted that other inorganic fillers or organic fillers can also be used in the composition of this invention in combination with h-BN or silica. Accordingly, in some embodiments, the film forming composition according to this invention comprises an inorganic filler. Suitable inorganic filler is the one which has a coefficient of thermal expansion (CTE) lower than that of the film formed from the composition of this invention. Non-limiting examples of such inorganic filler includes inorganic oxides such as, aluminum oxide (alumina), diatomaceous earth, titanium oxide, iron oxide, zinc oxide, magnesium oxide, metallic ferrite, germanium oxide, molybdenum oxide, tungsten oxide, zirconium dioxide, yttrium oxide; inorganic carbides such as silicon carbide, boron carbide, aluminum carbide, titanium carbide; inorganic nitrides such as aluminum nitride, silicon nitride, titanium nitride, gallium nitride, boron nitride carbide; inorganic boride such as silicon boride, titanium boride, yttrium boride, iron boride; inorganic sulfide such as gallium sulfide, molybdenum sulfide, tungsten disulfide; inorganic hydroxides such as aluminum hydroxide, zinc hydroxide, silicon hydroxide, magnesium hydroxide; inorganic carbonates such as calcium carbonate (light and heavy), magnesium carbonate, dolomite; inorganic phosphide such as aluminum phosphide, calcium phosphide, iron phosphide, nickel phosphide, iron nickel phosphide; various inorganic silicates known in the art, including lithium aluminum silicate, available as Lithafrax from St. Gobain; inorganic molybdate, such as zinc molybdate, available as Kemguard; inorganic stannate such as zinc stannate, available as Flamtard; inorganic sulfates such as calcium sulfate, barium sulfate, ammonium sulfate; and calcium sulfite; talc, mica; clay; glass fibers; montmorillonite; silicates such as calcium silicate, bentonite; borates such as zinc borate, barium metaborate, aluminum borate, calcium borate, and sodium borate; carbon black; carbon such as carbon fibers; iron powder; copper powder; aluminum powder; boronic fibers; potassium titanate; and lead zirconate. Various inorganic filler materials are commercially available, for example, a ceramic filler, Lithafrax-2121, is available from St. Gobain, among many other filler materials that may be suitable for using with the composition of this invention.

In some other embodiments the film forming composition according to this invention further comprises an organic filler, which is generally a synthetic resin maybe in the form of a powder or can be in any other suitable form or a polymer. Examples of such polymeric fillers include without any limitation, poly( [symbol] -methylstyrene), poly(vinyl-toluene), copolymers of [symbol] -methylstyrene and vinyl-toluene, and the like. Further examples of such synthetic resin powder include powders of various thermosetting resins or thermoplastic resins such as alkyd resins, epoxy resins, silicone resins, phenolic resins, polyesters, acrylic and methacrylic resins, acetal resins, polyethylene, polyethers, polycarbonates, polyamides, polysulfones, polystyrenes, polyvinyl chlorides, fluororesins, polypropylene, ethylene-vinyl acetate copolymers, and powders of copolymers of these resins. Other examples of the organic filler include aromatic or aliphatic polyamide fibers, polypropylene fibers, polyester fibers, aramid fibers, and the like.

In some embodiments the filler is treated with a coupling agent such as for example, silanes, zirconates, titanates, and the like. Exemplary silanes include silane compound having an alkoxysilyl group, an organic functional group such as an alkyl group, an epoxy group, a vinyl group, a phenyl group and a styryl group in one molecule. Such silane compounds include, for example, a silane having an alkyl group such as ethyltriethoxysilane, propyltriethoxysilane or butyltriethoxysilane (alkylsilane), a silane having a phenyl group such as phenyltriethoxysilane, benzyltriethoxysilane or phenethyltriethoxysilane, a silane having a styryl group such as styryltrimethoxysilane, butenyltriethoxysilane, propenyltriethoxysilane or vinyltrimethoxysilane (vinylsilane), a silane having an acrylic or methacrylic group such as γ-(methacryloxypropyl) trimethoxysilane, a silane having an amino group such as γ-aminopropyltriethoxysilane, N-β-(aminoethyl)-γ-aminopropyltrimethoxysilane, N-phenyl-γ-aminopropyltrimethoxysilane or an epoxy group such as γ-(3,4-epoxycyclohexyl) ureido triethoxysilane, and the like. Silanes having a mercapto group such as γ-mercaptopropyltrimethoxysilane or the like can also be used. It should further be noted that one or more of the aforementioned silane compounds can be used in any combination. Other coupling agents include without any limitation vinyltrichlorosilane, trivinylmethoxysilane, vinyltriethoxysilane, vinyltris(b-methoxyethoxy)silane, b-(3,4-epoxycyclohexyl)ethyltris-methoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryl-oxypropyltrimethoxysilane, γ-methacryloxypropylmethyldiethoxysilane, γ-methacryloxy-propyltriethoxysilane, N-b(aminoethyl)g-aminopropylmethyldimethoxysilane, N-b(amino-ethyl)g-aminopropyltrimethoxysilane, bis(trimethoxysilylethyl)benzene, bis(triethoxysilyl)-ethylene, triethoxysilyl-modified butadiene, styrylethyltrimethyloxysilane, N-b(aminoethyl)g-aminopropyltriethoxysilane, γ-aminopropyltrimethoxysilane, γ-aminopropyltriethoxysilane, N-phenyl-g-aminopropyltrimethoxysilane, trimethoxyphenylsilane, perfluorocotyltriethoxysilane, and g-mercaptopropyltrimethoxysilane.

It should further be noted that, when h-BN, silica or such similar inorganic material is used as the filler, it is generally treated with a “nonpolar silane compound,” but may not be required. This is to improve the adhesion between the cyclic olefin polymer and the respective filler used in the composition of this invention. As a result, the mechanical characteristics of the molded body can be improved. Advantageously, it has now been observed that treatment with a “nonpolar silane compound” can eliminate or reduce adverse effects on dielectric properties. As used herein, “nonpolar silane compound” refers to a silane compound having no polar substituent. Polar substituents refer to groups that can be hydrogen-bonded or ionically dissociated. Such polar substituents include, but are not limited to, —OH, —COOH, —COOH, NH₃, NR₄⁺A⁻, —CONH₂, and the like. Where, M is a cation such as an alkali metal, an alkaline earth metal or a quaternary ammonium salt, R is H or an alkyl group having 8 or less carbon atoms, and A is an anion such as a halogen atom.

In some embodiments, if h-BN or silica is used as the filler, its surface is modified with a vinyl group. It is advantageous to employ a vinyl group as it is a non-polar substituent, thus providing much needed low dielectric properties. In order to modify the surface of h-BN or silica with a vinyl group, for example, any one of the specific vinylsilanes listed above can be used.

It has now been observed that by incorporation of h-BN or silica as a filler it is now possible to reduce the coefficient of thermal expansion (CTE) of the compositions of this invention. Further, heat resistance can be improved. Accordingly, the thermal expansion coefficient can be reduced while the dielectric characteristic is improved. In some embodiments, by employing suitable amounts of h-BN or silica, which can be from about 20 pphr to 80 pphr, the dielectric constant (Dk) of the composition can be as low as 2.9 or lower and low loss (Df) less than about 0.002. In some other embodiments the Dk is in the range of from about 2.7 to about 2.8 and a dielectric dissipation factor (Df) from about 0.0011 to 0.002 at a frequency of 10 GHz. In some embodiments the film formed from the composition of this invention exhibits a UL-94 rating of at least V-1. In some other embodiments the film formed from the composition of this invention exhibits a UL-94 rating of V-0.

As noted, the composition according to this invention contains a tackifier. Generally, the purpose of the tackifier is not only to increase the adhesiveness of the composition but also to improve the softness of the composition especially while fabricating at temperatures higher than 130° C. so that the composition may have some flow to impregnate the glass cloth or to fuse with other layers of the device. The composition of this invention can generally be crosslinked at a temperature higher than 150° C., and it is beneficial to keep the composition soft at this temperature. Accordingly, any of the tackifiers that would bring about this benefit can be used in the compositions of this invention. In addition, the amount of tackifier used can also vary depending on the intended use. Generally, such amounts can range from about 5 to 30 parts per hundred parts of polymer (pphr), 8 to 25 pphr, 10 to 20 pphr, and so on. It should be noted that a combination of two or more tackifiers can also be used in the composition of this invention. In such situations the combined amount can be adjusted in order to provide the intended benefit.

Non-limiting examples of such tackifiers that are suitable in the composition of this invention may be enumerated as follows:

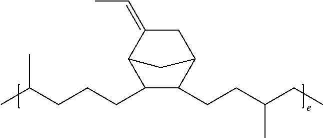

ethylene-propylene-ethylidenenorbornene terpolymer, where e is at least 100 (commercially available as TRILENE® T67 from Lion Elastomers);

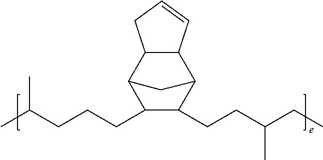

ethylene-propylene-dicyclopentadiene terpolymer, where e is at least 100 (commercially available as TRILENE® T65 from Lion Elastomers);

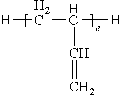

1,2-butadiene rubber, where e is at least 100 (commercially available as B1000 from Nisso America);

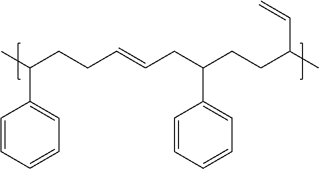

partially hydrogenated styrene/butadiene rubbers 1 (commercially available from Asahi Kasei as Tuftec P1083);

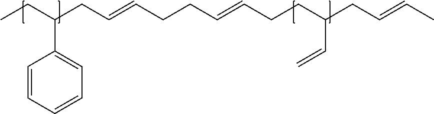

partially hydrogenated styrene/butadiene rubbers 2 (commercially available from Asahi Kasei as Tuftec 1500);

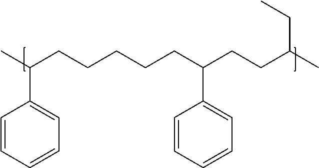

hydrogenated styrene/butadiene rubbers 1 (commercially available from Asahi Kasei as Tuftec H 1052); and

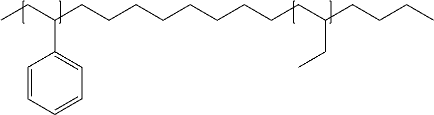

hydrogenated styrene/butadiene rubbers 2.

As noted, the composition of this invention further contains a free radical initiator. Any free radical initiator which will bring about the crosslinking reaction with the polymer and other components present in the composition and which facilitates adhesion to other suitable substrate such as for example copper and/or glass cloth can be used in the composition of this invention. Again, any amount of free radical initiator can be used which will bring about the intended benefit. Such amounts may vary and for example can range from about 1 pphr to 6 pphr of the free radical initiator.

Non-limiting examples of the free radical initiator that can be used in the composition of this invention include the following:

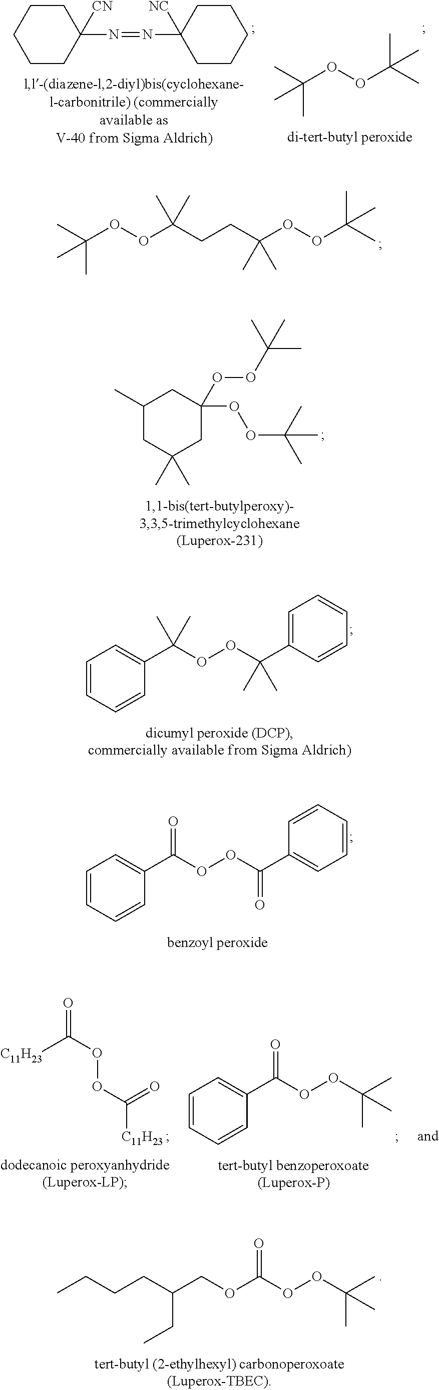

As noted, any of the first polymer, second polymer or a blend thereof as described herein can be employed in the composition of this invention. Generally, the composition of this invention is dissolved in a suitable solvent to form a homogeneous solution. Generally, such solvents to form the composition of this invention include for example, aromatic solvents such as toluene, mesitylene, xylenes, hydrocarbon solvents such as decalin, cyclohexane and methyl cyclohexane, ether solvent such as tetrahydrofuran (THF), ester solvent such as ethyl acetate, and a mixture in any combination thereof.

Non-limiting examples of the composition where no iron compound is used according to this invention are selected from the group consisting of:
a dispersion containing a mixture of melamine, a copolymer of norbornene (NB) and 5-vinylbicyclo[2.2.1]hept-2-ene (VNB); hexagonal boron nitride (h-BN), bentonite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP);
a dispersion containing a mixture of melamine, a copolymer of norbornene (NB) and 5-vinylbicyclo[2.2.1]hept-2-ene (VNB); hexagonal boron nitride (h-BN), kaolinite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP);
a dispersion containing a mixture of melamine, a copolymer of norbornene (NB) and 5-vinylbicyclo[2.2.1]hept-2-ene (VNB); hexagonal boron nitride (h-BN), sepiolite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP); and
a dispersion containing a mixture of melamine, a copolymer of norbornene (NB) and 5-vinylbicyclo[2.2.1]hept-2-ene (VNB); hexagonal boron nitride (h-BN), montmorillonite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP).

In some other embodiments, the composition of this invention additionally contains an iron compound such as for example ferric oxide as described herein. Non-limiting examples of such iron compound containing composition according to this invention are selected from the group consisting of:
a dispersion containing a mixture of melamine, a copolymer of norbornene (NB) and 5-vinylbicyclo[2.2.1]hept-2-ene (VNB); hexagonal boron nitride (h-BN), montmorillonite, ferric oxide, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP);
a dispersion containing a mixture of melamine, a terpolymer of norbornene (NB), 5-phenethylbicyclo[2.2.1]hept-2-ene (PENB) and 5-(cyclohex-3-en-1-yl)bicyclo[2.2.1]hept-2-ene (CyclohexeneNB); a copolymer of norbornene (NB) and 5-(cyclohex-3-en-1-yl)bicyclo[2.2.1]hept-2-ene (CyclohexeneNB); ferric oxide, montmorillonite, 1,3,5-triallyl-1,3,5-triazinane-2,4,6-trione (TAIC), 1,2-butadiene rubber (B1000), ethylene-propylene-ethylidenenorbornene terpolymer (T67), dicumyl peroxide (DCP), 3,5-bis(1,1-dimethylethyl)-4-hydroxy-octadecyl ester benzenepropanoic acid (Irganox 1076), tris(2,4-ditert-butylphenyl)phosphite (Irgafos 168) and 1-vinyl imidazole; and
a dispersion containing a mixture of melamine, a terpolymer of norbornene (NB), 5-phenethylbicyclo[2.2.1]hept-2-ene (PENB) and 5-(cyclohex-3-en-1-yl)bicyclo[2.2.1]hept-2-ene (CyclohexeneNB); a copolymer of norbornene (NB) and 5-(cyclohex-3-en-1-yl)bicyclo[2.2.1]hept-2-ene (CyclohexeneNB); ferric oxide, montmorillonite, silica, 1,3,5-triallyl-1,3,5-triazinane-2,4,6-trione (TAIC), 1,2-butadiene rubber (B1000), ethylene-propylene-ethylidenenorbornene terpolymer (T67), dicumyl peroxide (DCP), 3,5-bis(1,1-dimethylethyl)-4-hydroxy-octadecyl ester benzenepropanoic acid (Irganox 1076), tris(2,4-ditert-butylphenyl)phosphite (Irgafos 168) and 1-vinyl imidazole.

In general, the composition in accordance with the present invention encompass a polymer as described herein containing one or more distinct monomers of formula (I), and at least one monomer of formula (II), as it will be seen below, various composition embodiments are selected to provide properties to such embodiments that are appropriate and desirable for the use for which such embodiments are directed, thus, such embodiments are tailorable to a variety of specific applications. Accordingly, in some embodiments the composition of this invention encompasses a polymer containing more than two distinct monomers of formula (I), such as for example, three different monomers of formula (I) or four different monomers of formula (I) along with any desirable amount of monomer of formula (II), which can be as low as ten mole percent as noted above. Also, as noted in some embodiments only one or more monomers of formula (I) are employed.

For example, as already discussed above, by employing proper combination of different monomers of formula (I) and at least one monomer of formula (II) it is now possible to tailor a composition having the desirable low dielectric properties and thermal/mechanical properties, among other properties. In addition, it may be desirable to include other polymeric or monomeric materials which are compatible to provide desirable low-loss and low dielectric properties depending upon the end use application as further discussed in detail below.

Even more advantageously, it has now been found that employing at least one monomer of formula (II), surprisingly, even in small amounts it is now possible to form crosslink structures within the polymeric framework in combination with the crosslinking agent as described herein. That is, crosslinks can occur inter-molecular (i.e., between two cross-linkable sites on different polymer chains as well as intra-molecular (i.e., between two cross-linkable sites on the same polymer chain). Statistically, this can happen, and all such combinations are part of this invention. By forming such inter-molecular or intra-molecular crosslinks the polymers formed from the composition of this invention provide hitherto unobtainable properties. This may include for example improved thermal properties. That is, much higher glass transition temperatures than observed for non-crosslinked polymers of similar composition. In addition, such crosslinked polymers are more stable at higher temperatures, which can be higher than 300° C. High temperature stability can also be measured by well-known thermogravimetric analysis (TGA) methods known in the art. One such measurement includes a temperature at which the polymer loses five percent of its weight (T_{d5}). As will be seen below by specific examples that follow the T_{d5} of the polymers formed from the composition of this invention can generally be in the range from about 260° C. to about 320° C. or higher. In some embodiments, the T_{d5} of the polymers formed from the composition of this invention is in the range from about 270° C. to about 310° C.

The compositions in accordance with the present invention may further contain optional additives as may be useful for the purpose of improving properties of both the composition and the resulting object made therefrom. Such optional additives for example may include anti-oxidants and synergists. Any of the anti-oxidants that would bring about the intended benefit can be used in the compositions of this invention. Non-limiting examples of such antioxidants include pentaerythritol tetrakis(3-(3,5-di-tert-butyl-4-hydroxyphenyl)propionate) (IRGANOX™ 1010 from BASF), 3,5-bis(1,1-dimethylethyl)-4-hydroxy-octadecyl ester benzenepropanoic acid (IRGANOX™ 1076 from BASF) and thiodiethylene bis[3-(3,5-di-tert.-butyl-4-hydroxy-phenyl)propionate](IRGANOX™ 1035 from BASF). Non-limiting examples of such synergists include certain of the secondary antioxidants which may provide additional benefits such as for example prevention of autoxidation and thereby degradation of the composition of this invention and extending the performance of primary antioxidants, among other benefits. Examples of such synergists include, tris(2,4-ditert-butylphenyl)phosphite, commercially available as IRGAFOS 168 from BASF, various diamine synergists such as for example, N,N′-di-2-naphthyl-1,4-phenylenediamine, among others. Another synergist which may be suitable as an additive in the composition of this include certain diesters, such as for example, didodecyl 3,3′-thiodipropionate, whose structure is shown below:

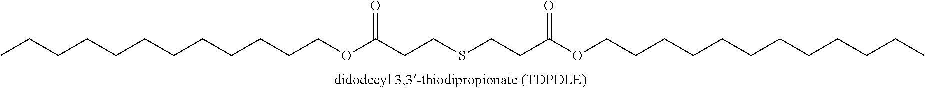 [SMILES: CCCCCCCCCCCCOC(=O)CCSCCC(=O)OCCCCCCCCCCCC]

Accordingly, the composition of this invention can be formed into films simply by following any of the known film casting techniques, including, for example, doctor blading, drum rolling, extrusion and/or spin coating, among other known methods. Accordingly, there is further provided a film formed from the composition of this invention. For example, any of the composition of this invention can be doctor-bladed onto a suitable substrate such as for example a glass plate. The coated plate is then heated to suitable temperature in an inert atmosphere to remove any residual solvent. Such temperatures can range from about 80° C. to 150° C. or 120° C. to 140° C. Suitable inert atmosphere can be nitrogen or argon. The heating at these temperatures for sufficient length of time will remove all of the residual solvent, for example a time interval of about 45 minutes to about 75 minutes. This initial stage of film forming is generally called as B-staged films. Under these conditions the film is still soluble in a suitable solvent such as for example THF, and is not fully crosslinked. The B-staged films are then further heated to higher temperature, which can range from about 150° C. to 220° C. or 160° C. to 190° C. in an inert atmosphere for sufficient length of time in order to affect the crosslinking of the film. Generally, such heating is carried out for about 90 minutes to 150 minutes to ensure full crosslinking of the composition, which is confirmed by insolubility of the polymer film.

The film thus formed in accordance with this invention exhibits unusually low dielectric constant, low loss, low coefficient of thermal expansion (CTE) and high glass transition temperature and more importantly fire-retardant properties. In some embodiments the film formed according to this invention exhibits a dielectric constant (Dk) less than 3, less than 2.9, less than 2.8, less than 2.7 at a frequency of 10 GHz, a glass transition temperature (T_{g}) in the range from about 150° C. to 250° C. or higher. In some other embodiments the T_{g} can be higher than 150° C., higher than 200° C., higher than 250° C. In yet some other embodiments the film according to this invention exhibits coefficient of thermal expansion (CTE) in the range of from about 80 ppm/K to 120 ppm/K, and a CTE less than 50 ppm/K when composited with glass cloth. The composition of this invention also exhibit excellent fire-retardant property. For example, in some embodiments the film formed from the composition of this invention exhibit UL-94 rating of at least V-1.

Accordingly, there is provided a film formed from the composition of this invention which does not contain any filler as described herein. In some such embodiments the film formed from the composition of this invention contains melamine in the amount of from about 100 parts by weight to about 150 parts by weight based on 100 parts by weight of the polymer and has a dielectric dissipation factor (Df) of less than 0.002 and a UL-94 rating of at least V-1.

In a further aspect of this invention there is further provided a film formed from the composition of this invention which contains one or more of the fillers as described herein. In some such embodiments the film formed from the composition of this invention contains melamine in the amount of from about 100 parts by weight to about 150 parts by weight based on 100 parts by weight of the polymer and has a dielectric dissipation factor (Df) of less than 0.002 and a UL-94 rating of at least V-1.

The film according to this invention can be formed from any one of the specific embodiments of the composition as enumerated hereinabove. In a further aspect of this invention there is also provided a film formed from any one of the specific embodiments of the composition of this invention.

It should additionally be noted that the crosslinked polymers formed from the composition of this invention may form thermosets thus offering additional advantages especially in certain applications where thermoplastics are not desirable. For example, any of the applications where higher temperatures are involved the thermoplastic polymers become less desirable as such polymeric materials may flow and are not suitable for such high temperature applications. Such applications include millimeter wave radar antennas as contemplated herein, among other applications.

The composition of the present invention may contain components other than those described above. The components other than the above include a coupling agent, a flame retardant, a release agent, an antioxidant, and the like. Non-limiting examples of the coupling agent include, silane coupling agents, such as, vinylsilanes, acrylic and methacrylic silanes, styrylsilanes, isocyanatosilanes, and the like. Adhesion between the composition of this invention and a base material or the like can be improved by using a silane coupling agent.

Various other flame retardant materials can also be used in combination with melamine as described herein. Non-limiting examples of such flame retardant include various halogen-based flame retardant such as a brominated epoxy resin, and an inorganic flame retardant such as aluminum hydroxide and magnesium hydroxide.

The composition of this invention may further include one or more compounds or additives having utility as, among other things, adhesion promoter, a surface leveling agent, a synergist, plasticizers, curing accelerators, and the like.

Surprisingly, it has now been found that employing one or more thermal free radical initiator as described herein it is now possible to accelerate the crosslinking of the polymer formed from the composition of this invention, resulting in a crosslinked polymer that exhibits much improved thermal properties. For example, both glass transition temperature (T_{g}) and temperature at which five weight percent weight loss occurs (T_{d5}) of the resulting polymer can be increased. Such increase in T_{g} can be substantial and can range from about 10° C. to 50° C. In some embodiments the T_{g} of the polymer is increased from 20° C. to 40° C. by employing suitable amounts of thermal free radical initiator. Similarly, the T_{d5} of the polymer can also be increased from about 3° C. to 10° C.

It should be noted that the composition of this invention can be formed into any shape or form and not particularly limited to film. Accordingly, in some embodiments the composition of this invention can be formed into a sheet. The thickness of the sheet is not particularly limited, but when the application as a dielectric material is considered, the thickness is, for example, 0.01 to 0.5 mm. In some other embodiments the thickness is from about 0.02 to 0.2 mm. The sheet so formed generally does not substantially flow at room temperature (25° C.). The sheet may be provided on an arbitrary carrier layer or may be provided alone. Examples of the carrier layer include a polyimide film or a glass sheet. Any other known peelable film substrates may be used as the carrier layer.

As described above, the film/sheet formed in accordance with this invention has good dielectric properties and can be tailored based on the types of components employed in the composition of this invention as described herein. In quantitative terms, the relative permittivity, i.e., the dielectric constant (Dk) of the film/sheet at a frequency of from about 10 GHz to 80 GHz is from about 2.7 to 2.9. The dielectric loss tangent (Df) at a frequency of 10 GHz to 80 GHz is from about 0.001 to 0.002. As it is apparent from these properties that the composition exhibits excellent dielectric properties even at very high frequencies with a marginal change in Dk/Df, and therefore, the composition of the present invention finds applications in a variety of devices where such low dielectric materials are needed, such as for example the dielectric polymeric layers used in the millimeter wave radar antenna used in automotive applications and various other terminal equipment used in 5G devices, among others. See for example, JP 2018-109090 and JP 2003-216823. An antenna is usually composed of an insulator and a conductor layer (for example, copper foil). The composition or sheet of the present invention can be used as a part or the whole of the insulator. The antenna using the composition or the sheet of the present invention as a part or the whole of the insulator has good high-frequency characteristics and reliability (durability). The use of such materials in printed circuit boards as Cu-clad laminates need high performance thermosets having high glass transition temperatures, low coefficients of thermal expansion (CTE), low Dk/Df, high peel strength on Cu and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in this area have not attained all these properties, especially low Dk/Df and high glass transition temperature.

The conductor layer in the antenna is formed of, for example, a metal having desirable conductivity. A circuit is formed on the conductor layer by using a known circuit processing method. Conductors forming the conductor layer include various metals having conductivity, such as gold, silver, copper, iron, nickel, aluminum, or alloy metals thereof. As a method for forming the conductor layer, a known method can be used. Examples include vapor deposition, electroless plating, and electrolytic plating. Alternatively, the metal foil (for example, copper foil) may be pressure-bonded by thermocompression bonding. The metal foil constituting the conductor layer is generally a metal foil used for electrical connection. In addition to the copper foil, various metal foils such as gold, silver, nickel, and aluminum can be used. It may also comprise an alloy foil substantially (for example, 98 wt % or more) composed of these metals. Among these metal foils, a copper foil is commonly used. The copper foil may be either a rolled copper foil or an electrolytic copper foil.

Advantageously, the composition of this invention fills the gap not hitherto attainable by the prior art materials. That is, as noted above, the compositions of this invention not only exhibit much needed low Dk/Df properties but also provides very high thermally stable materials as demonstrated by very high T_{g} and very high T_{d5} properties as discussed hereinabove.

Even more importantly the compositions of this invention can be formed into films/sheets of desirable thickness for forming various prepregs with glass cloth for fabricating into copper clad laminates. In some embodiments the film thickness of the films formed from the composition of this invention can be in the range of from about 75 to 150 microns, 90 to 120 microns suitable for forming metal clad laminates. In some embodiments the thickness can be lower than 75 microns or higher than 150 microns.

It should further be noted that various dielectric materials used in the applications mentioned herein must also withstand very harsh temperature conditions and must retain their dielectric properties for a long duration of time. Surprisingly, the films formed in accordance with this invention retain such low dielectric properties for a long period of time of up to 1000 hours or longer even when kept at high temperatures of about 125° C. or higher, thus providing additional benefit. The change of Dk or Df is very low, which can be as low as 3 percent or as low as one percent. Accordingly, in some embodiments of this invention the films formed in accordance with this invention retain substantially their Dk/Df properties for a period of 1000 hours or more at a temperature in the range of from about 120° C. to 150° C.

As noted, the composition of this invention is generally used as such to form a film or sheet. In addition, the composition of this invention can also be used as a low molecular weight varnish-type material for certain applications. The weight average molecular weight of the polymer (i.e., the second polymer as described hereinabove) used in such application can be as low as 1,000 or 2,000 or 3,000 or can be less than 10,000. Such low molecular weight polymers promote resin flow to promote flatness of the cured product including impregnation of glass cloth and coating the fillers. In such applications suitable amount of the desirable solvents can be added so as to maintain the solid content of the composition to about 10 to 70 weight percent when polymerized. Again, any of the solvents that are suitable to form such solutions can be used as a single solvent or a mixture of solvents as is needed for such application.

In a further aspect of this invention there is provided a kit for forming a film. There is dispensed in this kit a composition of this invention. Accordingly, in some embodiments there is provided a kit in which there is dispensed a polymer as described herein, one or more crosslinking agents as described herein, suitable amounts of melamine, iron compound as describe herein, fillers such as h-BN or silica, a tackifier, a free radical initiator as described herein; and one or more optional additives as described herein. In some embodiments the kit of this invention contains a polymer having two distinct monomers of formula (I) and a monomer of formula (II) in combination with at least one each of a crosslinking agent, melamine, a compound of formula (III) or ferric oxide optionally in combination with one or more fillers such as h-BN or silica, a tackifier as described herein, free radical initiator and an optional additive so as to obtain a desirable result and/or for intended purpose.

In another aspect of this embodiment of this invention the kit of this invention forms B-stageable film when subjected to suitable temperature for a sufficient length of time. That is to say that the composition of this invention is poured onto a surface or onto a substrate which needs to be encapsulated and exposed to suitable thermal treatment in order for the composition to form a crosslinked solid material which could be in the form of a film, or a sheet as described herein.

Generally, as already noted above, such crosslinking is performed in stages, first heating to a temperature lower than 150° C. for sufficient length of time, for example 5 minutes to 2 hours at each temperature stage to form a partially crosslinked solvent free B-stage film/sheet. The B-staged film can then be further heated to higher than 150° C. for example temperatures up to 190° C. or higher for various lengths of time such as from 90 minutes to 150 minutes so as to cure the film to form a fully crosslinked polymeric network. By practice of this invention, it is now possible to obtain polymeric films on such substrates which are substantially uniform films. The thickness of the film can be as desired and as specifically noted above, and may generally be in the range of 50 to 500 microns or higher.

While making a sheet and to secure the flatness of the sheet and suppressing unintended shrinkage, various heating methods known to make sheet materials may be employed. For example, it is possible to heat at a relatively low temperature at first, and then gradually raise the temperature. In order to ensure flatness or the like, including impregnation of glass cloth and coating the fillers by promoting resin flow, heating may be performed by pressurizing with a flat plate (metal plate) or the like before heating and/or by pressurizing with a flat plate. The pressure used for such pressurization may be, for example, 0.1 to 8 MPa, and in some other embodiments it may range from about 1 to 5 MPa.

In some embodiments, the kit as described herein encompasses various exemplary compositions as described hereinabove.

In yet another aspect of this invention there is further provided a method of forming a film for the fabrication of a variety of optoelectronic and/or automotive devices comprising:
forming a homogeneous clear composition comprising a polymer as described herein; suitable amounts of melamine; suitable amounts of a compound of formula (III) or ferric oxide; optionally suitable amounts of h-BN or silica, as needed; one or more crosslinking agent as described herein; a tackifier as described herein; a free radical initiator as described herein; and optionally one or more additives;
coating a suitable substrate with the composition or pouring the composition onto a suitable substrate to form a film; and
heating the film in stages to a suitable temperature to cause formation of the B-stageable film and then a cured film.

The coating of the desired substrate to form a film with the composition of this invention can be performed by any of the coating procedures as described herein and/or known to one skilled in the art, such as by spin coating. Other suitable coating methods include without any limitation spraying, doctor blading, meniscus coating, ink jet coating and slot coating. Other methods of coating also includes chemical vapor deposition depending upon the type of materials that is being coated. The mixture can also be poured onto a substrate to form a film. Suitable substrates include any appropriate substrate as is, or may be used for electrical, electronic, or optoelectronic devices, for example, a semiconductor substrate, a ceramic substrate, a glass substrate.

Next, the coated substrate is baked, i.e., heated to facilitate the removal of solvent and cross linking, for example to a temperature from 50° C. to 150° C. for about 1 to 180 minutes, although other appropriate temperatures and times can be used. That is, first forming the film by a B-stage process to remove any solvent present and then partially curing, and in a subsequent step at a higher temperature fully curing. In some embodiments the substrate is baked at a temperature of from about 100° C. to about 120° C. for 120 minutes to 180 minutes. In some other embodiments the substrate is baked at a temperature of from about 110° C. to about 140° C. for 60 minutes to 120 minutes. That is, these are the B-staged films. Finally, the B-staged films thus formed are further heated to temperatures higher than about 150° C. to fully cure the film.

The films thus formed are then evaluated for their electrical properties using any of the methods known in the art. For example, the dielectric constant (Dk) or permittivity and dielectric loss tangent at a frequency of 10 GHz was measured using a device for measuring the permittivity by the cavity resonator method (manufactured by AET, conforming to JIS C 2565 standard). The coefficient of thermal expansion (CTE) was measured using a thermomechanical analysis apparatus (for example, Seiko Instruments, SS 6000 or Mettler Toledo, TMA/STDA 2+STAR system) in accordance with a measurement sample size of about 4 mm (width)×40 mm (Length)×0.1 mm (thickness), a measurement temperature range of 30˜350° C., and a temperature rising rate of 5° C./min. The coefficient of linear expansion from 50° C. to 100° C. was adopted as the coefficient of linear expansion. Generally, the films formed according to this invention exhibit excellent dielectric and thermal properties and can be tailored to desirable dielectric and thermal properties as described herein.

Accordingly, in some of the embodiments of this invention there is also provided a film or sheet obtained by the composition as described herein. In another embodiment there is also provided an electronic device comprising the film/sheet of this invention as described herein.

The composition of this invention can also be formed into a variety of composite structures which can be used as prepreg materials in the fabrication of metal clad laminates. Various types of metals can be used for this purpose, including for example copper, aluminum, stainless steel, among others. Metal clad lamination is well known in the art where layers of metal are cladded with insulation materials, such as for example the composition of this invention. For example, the compositions of this invention can be impregnated onto a glass fabric and then formed into a prepreg in a B-stage process by heating to suitable temperatures as described herein. Then the prepregs thus formed are sandwiched between layers of copper or other metal foil and cured at a temperature higher than 150° C. while pressing the sandwiched stack to 0.1-8 MPa with the aid of two metal plates to form copper clad laminates. It should be noted that various other materials which can be used in place of glass fabric as familiar to one of skill in the art can also be used in this invention. Such other commonly used materials generally in the form of a fabric include without any limitation polyimide cloth/fabric, polybenzimidazole (PBI) cloth/fabric, and the like.

It has now been found that the laminates thus formed in accordance with this invention exhibits excellent peel strength. That is, the cured films of this invention are so strongly bonded to either the glass surface or the metal surface it is difficult to peel the film from such substrates. Even more advantageously, it has now been surprisingly found that the peel strength can be increased by using optimum levels of the free radical initiator. For example, use of very low levels, i.e., less than 0.5 pphr of the free radical initiator can result in the composition exhibiting unacceptable peel strength. Whereas use of free radical initiator in the range of about 2 to 3 pphr can provide surprisingly excellent peel strength. Accordingly, in some embodiments the peel strength of the composites formed in accordance with this invention can range from about 5 N/cm to about 8 N/cm or 9 N/cm or 11 N/cm or 13 N/cm or even higher depending upon the optimal amounts of free radical initiator used therein and the type of composite that is being made.

Accordingly, in some embodiments there is provided a glass fabric (cloth) composite film/cloth (i.e., a prepreg) formed from the composition of this invention, which exhibits a dielectric constant (Dk) less than 3, generally in the range of from about 2.7 to about 2.9 at a frequency of 10 GHz, a dielectric dissipation factor (Df) less than 0.003, generally in the range of from about 0.001 to 0.0021 at a frequency of 10 GHz and a UL-94 rating of V-0, a glass transition temperature higher than 220° C. and the temperature at which 5 percent weight loss occurs is higher than 250° C., a coefficient of thermal expansion (CTE) less than 80 ppm/K and excellent peel strength. In some other embodiments the glass fabric composite of this invention exhibits a dielectric constant (Dk) in the range of from about 2.7 to about 2.75 and a dielectric dissipation factor (Df) of about 0.0011 at a frequency of 10 GHz.

In some other embodiments there is provided a glass fabric (cloth) composite film/cloth (i.e., a prepreg) formed from the composition of this invention containing a clay and a filler such as h-BN or silica, which exhibits a dielectric constant (Dk) in the range of from about 2.7 to about 2.9 and a dielectric dissipation factor (Df) from about 0.001 to 0.002 at a frequency of 10 GHz and a UL-94 rating of at least V-0.

Advantageously, it has been further observed that the compositions of this invention can be coated uniformly onto a variety of glass or metal surfaces before curing such that any voids in the surface of such materials are fully covered. Then the coated surface is cured at a higher temperature to form a fully cured insulating layer, which is firmly bonded to such glass or metal surface. That is, for example, it is now possible to provide a metal foil with a coating of this composition to produce a printed wiring board or metal clad laminate in which the adhesion property between the insulating layer (i.e., the film formed from the composition of this invention), and the metal layer is excellent, and the loss at the time of signal transmission is further reduced.

Even more advantageously, it has now been found that the composition of this invention when applied onto a suitable surface can still flow and fill the voids before the two layers are well bonded. This is especially advantageous in the fabrication of metal clad laminates such as copper clad laminates where it is essential that all voids are completely insulated so as to further minimize loss at the time of signal transmission. Accordingly, in one aspect of this invention there is provided a method for producing a prepreg or a metal-clad laminate where a suitable glass fabric or a metal foil is coated with a composition of this invention and heated to suitable temperature in the range of from about 80° C. to 120° C. to form an uncured film of the composition of this invention on such glass fabric and/or metal foil. The composites thus formed are then cured at a higher temperature in the range of from about 160° C. to 180° C. while pressing using two metal plates to form fully cured laminates. It should particularly be noted that the polymers used in this aspect of the invention can be of very low molecular weight, such as for example the second polymer as described herein. That is, the weight average molecular weight (M_{w}) of the polymer employed in this aspect of the invention can be as low as 1,000 or can be in the range from about 1,000 to 5,000. The compositions of this invention exhibit excellent flow properties before they are fully cured and fill the surfaces uniformly on such glass fabric or metal foil, thus providing excellent insulating layer exhibiting very low dielectric constant and low loss properties as described herein.

The following examples are detailed descriptions of methods of preparation and use of certain compounds/monomers, polymers, and compositions of the present invention. The detailed preparations fall within the scope of, and serve to exemplify, the more generally described methods of preparation set forth above. The examples are presented for illustrative purposes only, and are not intended as a restriction on the scope of the invention. As used in the examples and throughout the specification the ratio of monomer to catalyst is based on a mole-to-mole basis.

### EXAMPLES (GENERAL)

The following abbreviations have been used hereinbefore and hereafter in describing some of the compounds, instruments and/or methods employed to illustrate certain of the embodiments of this invention:
NB—bicyclo[2.2.1]hept-2-ene; HexNB—5-hexylbicyclo[2.2.1]hept-2-ene; PENB—5-phenethylbicyclo[2.2.1]hept-2-ene; CyHexeneNB—5-(cyclohex-3-en-1-yl)bicyclo[2.2.1]hept-2-ene; VNB—5-vinylbicyclo[2.2.1]hept-2-ene; Pd785—palladium (II) bis(tricyclohexylphosphine) diacetate; Pd1206—(acetonitrile)bis(triisopropyl-phosphine)(palladium acetate)tetrakis(pentafluorophenyl borate); Pd601—palladium diacetate diadamantyl-(n-butyl)phosphine(H₂O); Pd1602—[Pd(OAc)(MeCN)-(PAd₂-n-Bu)₂]B(C₆F₅)₄; LiFABA—lithium tetrakis(pentafluorophenyl)borate diethyl etherate; DANFABA—dimethylanilinium tetrakis(pentafluorophenyl)borate; h-BN—hexagonal boron nitride; TAIC—1,3,5-triallyl-1,3,5-triazinane-2,4,6-trione; DCP—dicumyl peroxide; B1000—1,2-butadiene rubber; T67—ethylene-propylene-ethylidenenorbornene terpolymer; SA9000—poly-aryl ether cross linker end capped with methacrylate groups; Irganox-1076—3,5-bis(1,1-dimethylethyl)-4-hydroxy-octadecyl ester benzenepropanoic acid; Irgafos-168—tris(2,4-ditert-butylphenyl)phosphite; BCO—bicyclo[4.2.0]oct-7-ene; TES—triethylsilane; VIM—1-vinyl imidazole; EA—ethyl acetate; THF—tetrahydrofuran; IPA—isopropanol; GPC—gel permeation chromatography; M_{w}—weight average molecular weight; Mₙ—number average molecular weight; PDI—polydispersity index; NMR—nuclear magnetic resonance spectroscopy; DSC—differential scanning calorimetry; TGA—thermogravimetric analysis; TMA—thermomechanical analysis; pphr—parts per hundred parts resin, i.e., the polymer according to this invention and as specifically described hereinbelow.

Various monomers as used herein are either commercially available or can be readily prepared following the Diels-Alder procedures by employing the desired diene and the dienophile adduct.

### Flame Test Measurements

The compositions of this invention were first formed into films as described hereinbelow. The films thus formed were tested for fire-retardancy using the following procedure.

The rectangular test sample of about 1 cm×10 cm having the thicknesses ranging from 500-800 μm was placed vertically on a tip of a propane flame of about 2 cm high. The sample was allowed to burn for 10 seconds and removed from the flame. The time to extinguish the burning sample (designated as “After flame time t₁”) was noted. The same sample was placed on the flame again and allowed to burn for 10 seconds and removed from the flame. The time to extinguish the burning sample (designated as “After flame time t₂”) was noted. If both t₁ and t₂ are 10 seconds or less, sample self-extinguished, and any dripping flame did not cause a cotton pad placed beneath the flame to catch fire, the UL94 rating for the sample was deemed V0. If both t₁ and t₂ are 30 seconds or less, sample self-extinguished, and any dripping flame did not cause a cotton pad placed beneath the flame to catch fire, the UL94 rating for the sample was deemed V1. If both t₁ and t₂ are 60 seconds or less, sample self-extinguished, and any dripping flame did not cause a cotton pad placed beneath the flame to catch fire, the UL94 rating for the sample was deemed 5VA. If the samples were fully burnt, the UL94 rating was deemed NR (not rated).

### Peel Strength Measurements

For peel strength measurements, an ADMET Peel Strength Test Fixture having a pneumatic clamp of 250 N capacity was utilized in combination with an Instron Mdl. 5564 tensile tester. Rectangular samples of approximately 1.5 cm×6 cm were mounted on a plate using double-sided tape, and the copper foil tab was attached to the clamps in the instrument. The copper foil tab was pulled out of the sample at 5 mm/min rate at a 90° tilt while the average load of the peaks and troughs were registered. The peel strength of the laminated film on Cu surface at 90-deg tilt was measured by the highest 5 peaks method for the rectangular laminate of about 1.5 cm width.

### Dielectric Measurements

Dielectric constant (Dk) and dielectric dissipation factor (D_{f}) of glass cloth composite made in accordance of this invention having thicknesses ranging from 125-200 μm were measured at 10 GHz using a 2-port Vector Network Analyzer (300 kHz-14 GHz) from Keysight Technologies, Inc. 2020 Model P9373A using the resonance cavity method.

Various copolymers and terpolymers used in the composition of this invention were prepared in accordance with the procedures as set forth in Examples P1 to P13 as described below.

### Example P1

### Copolymer of NB/CyHexeneNB (80/20 Molar Ratio)

A solution of NB (753.2 g, 8000 mmol, as 75 weight percent solution in toluene), CyHexeneNB (348.6 g, 360 mmol), TES (348.9 g, 3000 mmol), and DANFABA (2.40 g, 3.00 mmol) dissolved in cyclohexane (7200 g) was placed in a glass reactor and flushed with nitrogen. This solution was heated to 110° C. To this solution was added Pd1206 (1.2 g, 1 mmol, 0.5 wt. % solution in anhydrous EA). The heating of the reaction mixture at 110° C. while stirring was continued for 4 hours. At which time the polymerized mixture was cooled and poured to IPA while stirring rapidly to precipitate out the solid polymer. The solid was filtered and dried in an oven at 50° C. under vacuum to obtain the dry polymer. GPC (THF): M_{w}=1,450, Mₙ=550, PDI=2.66. The monomer composition in the copolymer was calculated by ¹H NMR (CDCl₃): NB/CyHexeneNB—85/15.

### Example P2

### Copolymer of NB/VNB (80/20 Molar Ratio)

A solution of NB (110.4 g, 880 mmol as 75 wt. % solution in toluene), VNB (26.5 g, 220 mmol), TES (38.4 g, 330 mmol), and DANFABA (0.26 g, 33 mmol) dissolved in cyclohexane (705 g) was placed in a glass reactor and flushed with nitrogen. This solution was heated to 110° C. To this solution was then added Pd1206 (0.13 g, 11 mmol as 0.5 wt. % solution in EA). The heating of the reaction mixture at 110° C. while stirring was continued for 4 hours. The solid polymer was isolated and dried under similar conditions as set forth in Example P1. GPC (THF): M_{w}=1,700, Mₙ=575, PDI=2.97. The monomer composition in the copolymer was calculated by ¹H NMR (CDCl₃): NB/VNB, 86/14.

### Example P3

### Terpolymer of NB/HexNB/CyHexeneNB (70/10/20 Molar Ratio)

A solution of NB (131.8 g, 1400 mmol, as 75 wt. % solution in toluene), HexNB (35.7 g, 200 mmol) CyHexeneNB (69.7 g, 400 mmol), BCO (1.62 g, 15.0 mmol) and LiFABA (0.26 g, 0.3 mmol) dissolved in anhydrous toluene (899 g) was placed in a glass reactor and flushed with nitrogen. This solution was heated to 80° C. in a nitrogen atmosphere. To this solution was added Pd1602 (0.16 g, 0.1 mmol in a 1.3 wt. % solution in anhydrous EA). The heating of the reaction mixture at 80° C. while stirring was continued for 6 hours. To this reaction mixture toluene (1750 g) was added. The diluted polymerized mixture was cooled to room temperature and poured in three batches of about 570 g each to excess IPA (about 2700 g each) while stirring rapidly to precipitate the polymer. The solid polymer was isolated by filtering out the solvent and was dried in a vacuum oven at 80-90° C. for 20-30 hours to obtain the purified polymer (227 g, 96% yield). GPC (cyclohexane/decalin): M_{w}=117,325, Mₙ=26,950, PDI=4.35. The monomer composition in the terpolymer was calculated by ¹³C NMR (CDCl₃): NB/HexNB/CyHexeneNB, 70/10/20.

### Example P4

### Terpolymer of NB/PENB/CyHexeneNB (70/10/20 Molar Ratio)

A solution of NB (82.4 g, 875 mmol, as 75 weight percent solution in toluene), PENB (24.8 g, 125 mmol), CyHexeneNB (43.6 g, 250 mmol), BCO (1.76 g, 16 mmol), and LiFABA (0.33 g, 0.38 mmol) dissolved in toluene (655 g) was taken in a glass reactor, and flushed with nitrogen. This solution was heated to 80° C. in a nitrogen atmosphere. To this solution was added Pd601 (0.08 g, 0.13 mmol, 3.9 wt. % solution in anhydrous THF). The heating of the reaction mixture at 80° C. while stirring was continued for 4 hours. The polymerized mixture was cooled to room temperature, diluted with toluene, and poured into excess IPA while stirring rapidly to precipitate the polymer. The liquids filtered out and the solids were dried in a vacuum oven at 50° C. to obtain the purified polymer. GPC (THF): M_{w}=100,750, Mₙ=31,100, PDI=3.24. The monomer composition in the terpolymer was calculated by ¹H NMR (CDCl₃): NB/PENB/CyHexeneNB, 68/11/21.

### Example P5

### Terpolymer of NB/HexNB/VNB (70/10/20 Molar Ratio)

A solution of NB (158.2 g, 1260 mmol, as 75 weight percent solution in toluene), HexNB (32.1 g, 180 mmol), VNB (43.2 g, 360 mmol), TES (2.3 g, 20 mmol), and LiFABA (0.26 g, 0.27 mmol) dissolved in toluene (719 g) was taken in a glass reactor and heated to 80° C. To this solution was added Pd601 (0.06 g, 0.09 mmol, 1.4 wt. % solution in anhydrous THF) and heating was continued for 4 hours. The polymer solution was cooled to room temperature, diluted with toluene, and poured into excess IPA while stirring to separate the solid polymer. The solid polymer was dried at 50° C. in an oven under vacuum to obtain a dry polymer (189 g, 81% isolated yield). GPC (THF): M_{w}=71,450, Mₙ=21,375, PDI=3.34. The monomer composition in the terpolymer was calculated by ¹³C NMR (CDCl₃): NB/PENB/VNB, 58/14/28.

### Example P6

### Terpolymer of NB/PENB/VNB (70/10/20 Molar Ratio)

A solution of NB (82.4 g, 875 mmol, as 75 weight percent solution in toluene), PENB (24.8 g, 125 mmol), VNB (30.1 g, 250 mmol), BCO (1.76 g, 16 mmol), and LiFABA (0.30 g, 0.38 mmol) dissolved in toluene (594 g) taken in a glass reactor was heated to 80° C. To this solution was added Pd601 (0.08 g, 0.13 mmol, 3.9 wt. % solution in anhydrous THF) and the heating at 80° C. was continued for 4 hours. The reaction mixture was then cooled to room temperature, diluted with toluene, and poured into IPA to precipitate the polymer. The polymer thus isolated was dried at 50° C. in an oven under vacuum. GPC (THF): M_{w}=100,000, Mₙ=29,700, PDI=3.37. The monomer composition in the terpolymer was calculated by ¹H NMR (CDCl₃): NB/PENB/VNB, 71/10/19.

### Examples 1A to 1R

### Fire-Retardant Composition Containing Melamine and Clay

The copolymer, NB/VNB (80/20), as prepared in Example P2 was dissolved in toluene to prepare 60 wt. % solution. To this solution was added B1000 (20 pphr), T67 (7.5 pphr), TAIC (10 pphr) and DCP (3 pphr) to form a pre-composition. Portions of this pre-composition (10 g) was mixed well with melamine (3.8 g, 100 pphr). Various clay acid catalysts and ferric oxide were also added to prepare various compositions as listed in Table 1. All of the compositions except compositions of Examples 1A and 1C also contained h-BN (50 pphr, 0.7 m from Showa Denko). The composition of Example A was simply a pre-composition and did not contain any melamine, h-BN, ferric oxide or clay acid catalyst. The composition of Example 1B had only h-BN as a filler and did not contain any melamine or ferric oxide or clay acid catalysts. The composition of Example 1C had melamine (100 pphr) as a flame-retardant but did not contain any ferric oxide or clay acid catalysts or filler (h-BN).

TABLE 1

| Ex. | | | Ferric | | | | |
|---|---|---|---|---|---|---|---|
| No. | Melamine | h-BN | Oxide | Bentonite | Kaolinite | Sepiolite | Montmorillonite |
| 1A | — | — | — | — | — | — | — |
| 1B | — | 50 pphr | — | — | — | — | — |
| 1C | 100 pphr | — | — | — | — | — | — |
| 1D | 100 pphr | 50 pphr | — | — | — | — | — |
| 1E | 100 pphr | 50 pphr | — | 5 pphr | — | — | — |
| 1F | 100 pphr | 50 pphr | — | 10 pphr | — | — | — |
| 1G | 100 pphr | 50 pphr | — | 20 pphr | — | — | — |
| 1H | 100 pphr | 50 pphr | — | — | 5 pphr | — | — |
| 1I | 100 pphr | 50 pphr | — | — | 10 pphr | — | — |
| 1J | 100 pphr | 50 pphr | — | — | 20 pphr | — | — |
| 1K | 100 pphr | 50 pphr | — | — | — | 5 pphr | — |
| 1L | 100 pphr | 50 pphr | — | — | — | — | 5 pphr |
| 1M | 100 pphr | 50 pphr | — | — | — | — | 10 pphr |
| 1N | 100 pphr | 50 pphr | — | — | — | — | 15 pphr |
| 1O | 100 pphr | 50 pphr | — | — | — | — | 20 pphr |
| 1P | 100 pphr | 50 pphr | 2 pphr | — | — | — | — |
| 1Q | 100 pphr | 50 pphr | 2 pphr | — | — | — | 10 pphr |
| 1R | 100 pphr | 50 pphr | 2 pphr | — | — | — | 15 pphr |

Several low loss glass cloths (5 cm×5 cm) were wetted separately with each of the flame-retardant compositions of Examples 1A-1R and the solvent removed (B3-staged) at 110° C. for 1 hour in an oven under nitrogen atmosphere. These samples for dielectric property measurements were cured at 200° C. for 2 hours at 3 MPa pressure in a heated press. The samples wetted with the flame retardant compositions of Examples 1P, 1Q and 1R were cured at 200° C. for 2 hours in an oven under nitrogen atmosphere. Film thicknesses of these dielectric measurement samples ranged from 150-250 μm.

Similarly, low loss glass cloths (3 cm×10 cm) were wetted with flame-retardant compositions of Examples 1A-1R. Solvent removed (B-staged) at 110° C. for 1 hour in an oven under nitrogen atmosphere of stacks of these wetted glass cloths (4-5 pieces) and cured at 200° C. for 2 hours at 3 MPa pressure in a heated press. The thicknesses of the flame test samples ranged between 600-800 μm. The cured samples were cut into about 1 cm×10 cm flame test specimens.

Dielectric constants (Dk) and dielectric dissipation factors (Df) of the cured samples at 10 GHz frequency and flame test results are summarized in Table 2.

TABLE 2

| | | | | | UL94 |
|---|---|---|---|---|---|
| Example No. | Dk | Df | After flame-1 | After flame-2 | Rating |
| Example 1A | 2.79 | 0.0016 | 4, 8 | 0, 0 | NR(2) |
| Example 1B | 2.69 | 0.0016 | 9, 2 | 0, 0 | NR(2) |
| Example 1C | 2.69 | 0.0015 | 34, 22, 12, 11 | 0, 0, 0, 0 | V1(3), 5VA(1) |
| Example 1D | 2.66 | 0.0011 | 0, 3, 0, 7, 0 | 10, 0, 37, 0, 20 | V0(3), V1(1), NR(1) |
| Example 1E | 2.82 | 0.0014 | 1, 3, 23, 2, 27, 0 | 0, 6, 3, 0, 0, 0 | V0(4), V1(1) |
| Example 1F | 2.70 | 0.0017 | 0, 2, 0, 11, 4 | 3, 19, 28, 0, 13 | V0(1), V1(4) |
| Example 1G | 2.79 | 0.0024 | 4, 1, 4, 21 | 14, 0, 10, 0 | V0(2), V1(2) |
| Example 1H | 2.87 | 0.0017 | 1, 12, 0, 16, 4, 11 | 0, 0, 10, 0, 0, 0 | V0(3), V1(3) |
| Example 1I | 2.77 | 0.0018 | 0, 3, 6, 13, 0, 0 | 0, 0, 3, 0, 9, 0 | V0(5), V1(2) |
| Example 1J | 2.76 | 0.0022 | 5, 0, 8, 0 | 1, 17, 0, 12 | V0(2), V1(2) |
| Example 1K | 2.82 | 0.0011 | 15, 17, 28 | 0, 0, 0 | V1(2), NR(1) |
| Example 1L | 2.74 | 0.0011 | 5, 4, 20, 16, 27, 0 | 3, 16, 0, 0, 0, 6 | V0(2), V1(4) |
| Example 1M | 2.73 | 0.0013 | 0, 1, 0, 0, 0, 1 | 8, 0, 0, 3, 17, 26 | V0(4), V1(2) |
| Example 1N | 2.79 | 0.0015 | 3, 0, 0, 0 | 18, 0, 0, 0 | V0(3), V1(1) |
| Example 1O | 2.74 | 0.0018 | 3, 1, 0, 3 | 0, 22, 21, 6 | V0(2), V1(2) |
| Example 1P | 2.75 | 0.0014 | 19, 1, 0, 2 | 0, 0, 4, 0 | V0(3), V1(1) |
| Example 1Q | 2.71 | 0.0021 | 0, 0, 0, 0 | 0, 0, 3, 5 | V0(4) |
| Example 1R | 2.76 | 0.0024 | 0, 0, 0, 0 | 0, 0, 3, 5 | V0(4) |

### Examples 2A and 2B

### Fire-Retardant Compositions Containing Polymer Blend

Terpolymer, NB/PENB/CyHexeneNB (70/10/20), from Example P4 was dissolved in toluene to prepare 20 wt. % solution. To this solution was added B1000 (10 pphr), T67 (10 pphr), TAIC (10 pphr), DCP (3 pphr), Irganox-1076 (1.75 pphr) and Irgafos-168 (0.75 pphr) to form a pre-composition A. Similarly, copolymer, NB/CyHexeneNB (80/20), from Example P1 was dissolved in toluene to prepare 60 wt. % solution. To this solution was added B1000 (10 pphr), T67 (11.3 pphr), TAIC (10 pphr), DCP (3 pphr), Irganox-1076 (1.75 pphr) and Irgafos-168 (0.75 pphr) to form a pre-composition B. These two pre-compositions A and B were mixed to form a blend of 70 wt. % terpolymer, NB/PENB/CyHexeneNB (70/10/20) and 30 wt. % copolymer, NB/CyHexeneNB (80/20), designated as pre-composition C.

Melamine (125 pphr), ferric oxide-2 (7 pphr), VIM (3 pphr) and montmorillonite (10 pphr) were added to the pre-composition C to prepare the flame retardant composition of Example 2A. Flame retardant composition of Example 2B contained melamine (125 pphr), ferric oxide-2 (7 pphr), VIM (3 pphr), silica (SV2300, 50 pphr) and montmorillonite (10 pphr).

Low loss glass cloth (5 cm×5 cm) was wetted separately with each of the flame-retardant compositions of Examples 2A and 2B and the solvent removed (B-staged) at 130° C. for 1 hour in an oven under nitrogen atmosphere. These samples for dielectric property measurements were cured at 200° C. for 2 hours at 3 MPa pressure in a heated press. Film thicknesses of these dielectric measurement samples ranged from 150-250 μm. Similarly, low loss glass cloths (3 cm×10 cm) were separately wetted with each of the flame-retardant compositions of Examples 2A and 2B. Solvent removed (B-staged) at 130° C. for 1 hour in an oven under nitrogen atmosphere of stacks of these wetted glass cloths (4-5 rectangles) and cured at 200° C. for 2 hours at 3 MPa pressure in a heated press. The thicknesses of the flame test samples ranged between 600-800 μm. The cured samples were cut into about 1 cm×10 cm flame test specimens.

Dielectric constants (Dk) and dielectric dissipation factors (Df) of the cured samples at 10 GHz frequency and flame test results are summarized in Table 3.

TABLE 3

| | | | | | UL94 |
|---|---|---|---|---|---|
| Example No. | Dk | Df | After flame-1 | After flame-2 | Rating |
| Example 2A | 2.77 | 0.0021 | 4, 0, 0, 0, 8, 2, | 4, 0, 0, 9, 3, | V0(8) |
| | | | 0, 0 | 0, 0, 0 | |
| Example 2B | 2.85 | 0.003 | 18, 0, 0, 0, 0, | 0, 0, 5, 0, 0, | V0(7), |
| | | | 0, 0, 0 | 0, 3, 0 | V1(1) |

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

1. A composition comprising:
a) melamine;
b) a polymer selected from the group consisting of a first polymer having a weight average molecular weight (M_{w}) of at least 50,000, a second polymer having a weight average molecular weight (M_{w}) of at least 1,000 and a blend of the first polymer and the second polymer, where said polymer comprising:
i) at least one first repeating unit represented by formula (IA), said first repeating unit is derived from a monomer of formula (I): 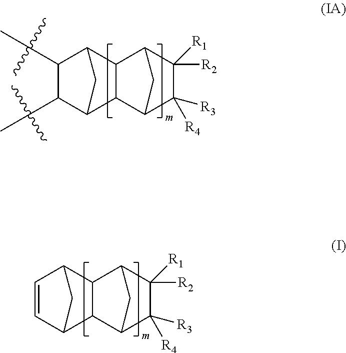
wherein: [symbol]
denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
ii) at least one second repeating unit represented by formula (IIA), said second repeating unit is derived from a monomer of formula (II): 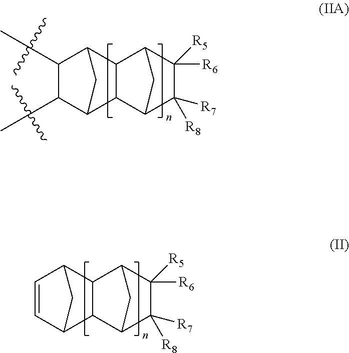
wherein: [symbol]
denotes a place of bonding with another repeat unit;
n is an integer 0, 1 or 2;
at least one of R₅, R₆, R₇ and R₈ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl; and
the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond;
and
wherein the second repeat unit is present at an amount of at least ten mole percent based on total moles of first and second repeat units;
c) a crosslinking agent selected from the group consisting of: 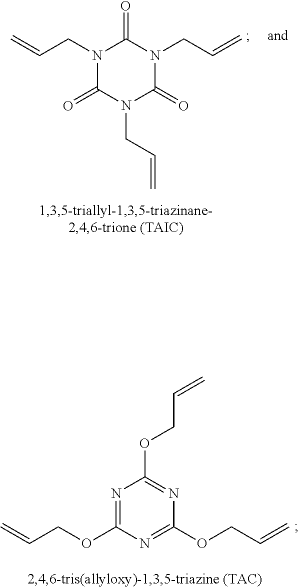
d) a clay selected from the group consisting of bentonite, kaolinite, sepiolite and montmorillonite;
e) a filler selected from the group consisting of hexagonal boron nitride and silica;
f) a tackifier; and
g) one or more additives selected from the group consisting of a free radical initiator, an antioxidant, a synergist and a mixture in any combination thereof; and
wherein melamine is present at an amount of at least about 100 parts by weight based on 100 parts by weight of polymer and said composition when formed into a film has a UL-94 rating of at least V-1, a dissipation factor (Df) of less than 0.002 at 10 GHz.

2. The composition according to claim 1, wherein the first repeat unit of the polymer is derived from the monomer of formula (I) selected from the group consisting of:

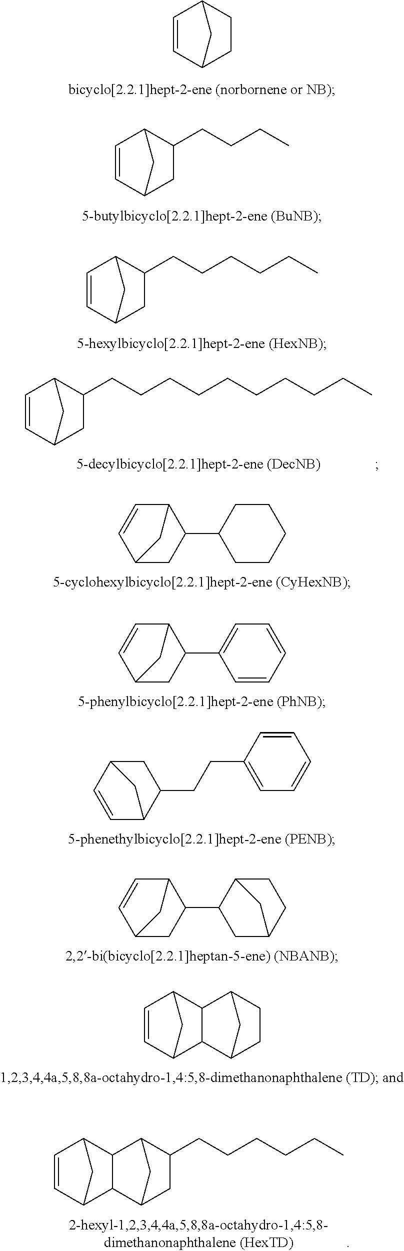

3. The composition according to claim 1, wherein the second repeat unit of the polymer is derived from the monomer of formula (II) selected from the group consisting of:

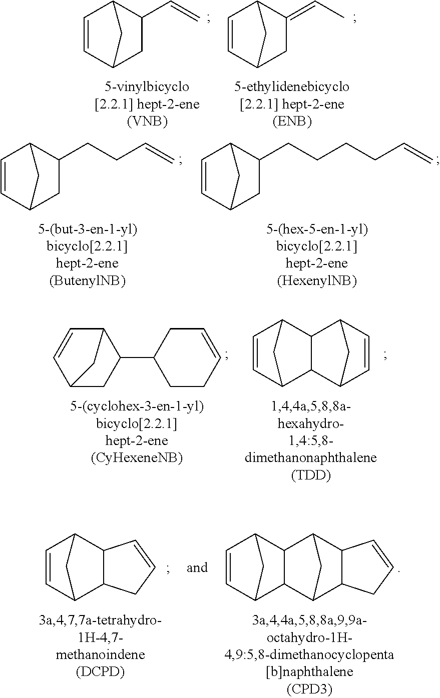

4. The composition according to claim 1, wherein the second repeat unit of the polymer is present at an amount in the range of from about ten mole percent to about thirty mole percent based on total moles of first and second repeat units.

5. The composition according to claim 1, wherein the polymer is a blend of the first polymer and the second polymer; and wherein the blend contains at least 20 parts by weight of the second polymer based on 100 parts by weight of the blend.

6. The composition according to claim 1 further comprising an iron compound selected from the group consisting of ferric oxide and a compound of formula (III): 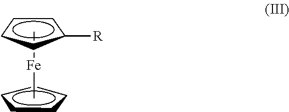
wherein:
R is selected from the group consisting of hydrogen, methyl, ethyl, linear or branched (C₃-C₁₆)alkyl, vinyl, linear or branched (C₃-C₁₆)alkenyl, (C₃-C₁₀)cycloalkyl, (C₆-C₁₂)bicycloalkyl, (C₆-C₁₂)aryl, (C₆-C₁₂)aryl(C₁-C₆)alkyl, (C₂-C₁₆)alkanoyl, di-(C₁-C₆)alkylamino(C₃-C₆)alkyl, di-(C₁-C₆)alkylamino, hydroxy, hydroxy(C₁-C₆)alkyl, methoxy, ethoxy, linear or branched (C₃-C₁₆)alkoxy and (C₆-C₁₂)aryloxy;
and wherein the compound of formula (III) is selected from the group consisting of:

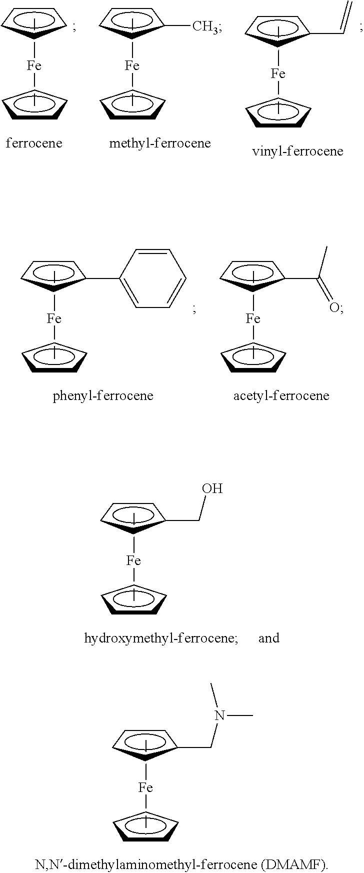

7. The composition according to claim 6, wherein the iron compound is present at an amount of at least two parts by weight based on 100 parts by weight of the polymer.

8. The composition according to claim 1, wherein the filler is hexagonal boron nitride.

9. The composition according to claim 1, wherein the filler is present at an amount in the range of from about 30 parts by weight to about 80 parts by weight based on 100 parts by weight of the polymer.

10. The composition according to claim 1, wherein the tackifier is selected from the group consisting of: 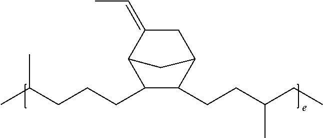
ethylene-propylene-ethylidenenorbornene terpolymer, where e is at least 100 (T67); 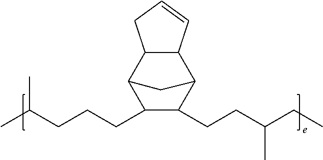
ethylene-propylene-dicyclopentadiene terpolymer, where e is at least 100 (T65); 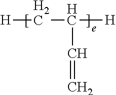
1,2-butadiene rubber, where e is at least 100 (B1000); 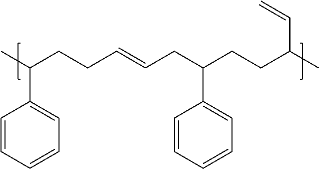
styrene/butadiene rubbers 1; 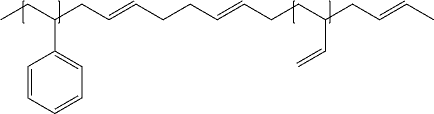
styrene/butadiene rubbers 2; 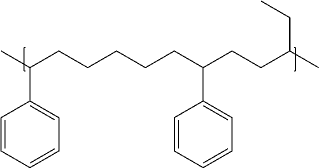
hydrogenated styrene/butadiene rubbers 1; and 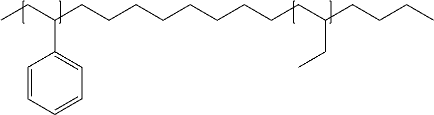
hydrogenated styrene/butadiene rubbers 2.

11. The composition according to claim 1, wherein the free radical initiator is selected from the group consisting of:

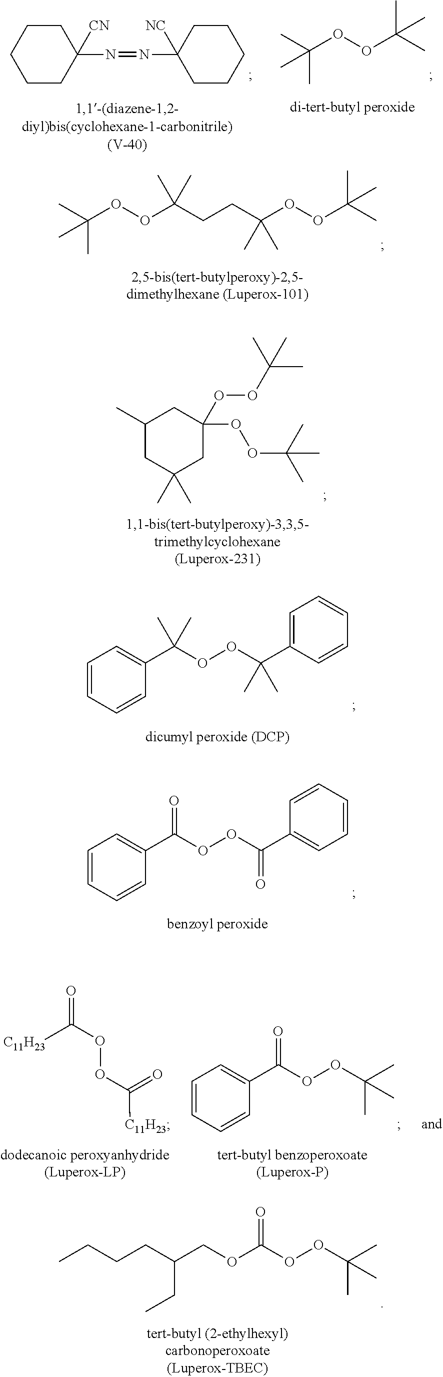

12. The composition according to claim 1, which is selected from the group consisting of:
a dispersion containing a mixture of melamine, a copolymer of norbornene (NB) and 5-vinylbicyclo[2.2.1]hept-2-ene (VNB); hexagonal boron nitride (h-BN), bentonite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP);
a dispersion containing a mixture of melamine, a copolymer of norbornene (NB) and 5-vinylbicyclo[2.2.1]hept-2-ene (VNB); hexagonal boron nitride (h-BN), kaolinite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP);
a dispersion containing a mixture of melamine, a copolymer of norbornene (NB) and 5-vinylbicyclo[2.2.1]hept-2-ene (VNB); hexagonal boron nitride (h-BN), sepiolite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP); and
a dispersion containing a mixture of melamine, a copolymer of norbornene (NB) and 5-vinylbicyclo[2.2.1]hept-2-ene (VNB); hexagonal boron nitride (h-BN), montmorillonite, 1,3,5-triallyl-1,3,5-triazinane-2,4,6-trione (TAIC), 1,2-butadiene rubber (B1000), ethylene-propylene-ethylidenenorbornene terpolymer (T67) and dicumyl peroxide (DCP).

13. A film formed from the composition according to claim 1.

14. The film according to claim 13, which contains melamine in the amount of from about 100 parts by weight to about 150 parts by weight based on 100 parts by weight of the polymer and has a dielectric dissipation factor (Df) of less than 0.002 and a UL-94 rating of at least V-1.

15. The composition according to claim 6, which is selected from the group consisting of:
a dispersion containing a mixture of melamine, a terpolymer of norbornene (NB), 5-phenethylbicyclo[2.2.1]hept-2-ene (PENB) and 5-(cyclohex-3-en-1-yl)bicyclo[2.2.1]hept-2-ene (CyclohexeneNB); a copolymer of norbornene (NB) and 5-(cyclohex-3-en-1-yl)bicyclo[2.2.1]hept-2-ene (CyclohexeneNB); ferric oxide, montmorillonite, 1,3,5-triallyl-1,3,5-triazinane-2,4,6-trione (TAIC), 1,2-butadiene rubber (B1000), ethylene-propylene-ethylidenenorbornene terpolymer (T67), dicumyl peroxide (DCP), 3,5-bis(1,1-dimethylethyl)-4-hydroxy-octadecyl ester benzenepropanoic acid (Irganox 1076), tris(2,4-ditert-butylphenyl)phosphite (Irgafos 168) and 1-vinyl imidazole; and
a dispersion containing a mixture of melamine, a terpolymer of norbornene (NB), 5-phenethylbicyclo[2.2.1]hept-2-ene (PENB) and 5-(cyclohex-3-en-1-yl)bicyclo[2.2.1]hept-2-ene (CyclohexeneNB); a copolymer of norbornene (NB) and 5-(cyclohex-3-en-1-yl)bicyclo[2.2.1]hept-2-ene (CyclohexeneNB); ferric oxide, montmorillonite, silica, 1,3,5-triallyl-1,3,5-triazinane-2,4,6-trione (TAIC), 1,2-butadiene rubber (B1000), ethylene-propylene-ethylidenenorbornene terpolymer (T67), dicumyl peroxide (DCP), 3,5-bis(1,1-dimethylethyl)-4-hydroxy-octadecyl ester benzenepropanoic acid (Irganox 1076), tris(2,4-ditert-butylphenyl)phosphite (Irgafos 168) and 1-vinyl imidazole.

16. A film formed from the composition according to claim 8.

17. The film according to claim 16, which contains melamine in the amount of from about 100 parts by weight to about 150 parts by weight based on 100 parts by weight of the polymer and has a dielectric dissipation factor (Df) of less than 0.002 and a UL-94 rating of at least V-1.

18. A glass fabric composite formed from the composition of claim 1.

19. A glass fabric composite formed from the composition of claim 8.

20. The glass fabric composite according to claim 19, which has a dielectric constant (Dk) in the range of from about 2.7 to about 2.9 and a dielectric dissipation factor (Df) from about 0.0011 to 0.003 at a frequency of 10 GHz and a UL-94 rating of at least V-1.
